(19) United States
(12) Patent Application Publication
(10) Pub. No.: US 2009/0319512 A1
(43) Pub. Date: Dec. 24, 2009

(54) AGGREGATOR, FILTER, AND DELIVERY SYSTEM FOR ONLINE CONTENT

(76) Inventors: Douglas Baker, Eden Prairie, MN (US); Robert N. Haselmann, Eden Prairie, MN (US); James Dennis Musil, Minneapolis, MN (US); Jeffrey Lee O'Dell, Deephaven, MN (US); Michael Paul O'Dell, Minneapolis, MN (US); Sergey Tolkachev, Bloomington, MN (US); Lee Zukor Alden, Minneapolis, MN (US)

Correspondence Address: MERCHANT & GOULD PC, P.O. BOX 2903, MINNEAPOLIS, MN, 55402-0903, US

(21) Appl. No.: 12/355,249

(22) Filed: Jan. 16, 2009

Related U.S. Application Data
(60) Provisional application No. 61/022,219, filed on Jan. 18, 2008.

(51) Int. Cl. G06F 17/30

(52) U.S. Cl. 707/5; 707/E17.109

(57) ABSTRACT

A computing device that filters online content to be delivered to an individual includes a processor, and a computer readable storage medium storing instructions. When the instructions are executed, the computing device is caused to: receive content from a plurality of sources, and to index the content; receive input from the individual to indicate a relevance of certain of the content; filter the content based on the input from the individual and identify relevant content for the individual; and deliver the relevant content to the individual.

### RELATED APPLICATION

This application claims the benefit of U.S. Patent Application Ser. No. 61/022,219 filed on Jan. 18, 2008, the entirety of which is hereby incorporated by reference.

### BACKGROUND

As the content available on the Internet grows, the popularity of search engines like Google, Yahoo, and MSN that help individuals find information on the Internet has also grown. Today's search engines index billions of web pages and allow individuals to search the indexes in an attempt to locate desired information.

A variety of strategies are used to rank and present search results to an individual. One of the most prevalent mechanisms is the use of weighting algorithms that estimate a page rank based on various parameters, such as the number of links to and from a page. Most search engines are configured to rank search results provided to the individual based on the weighting provided by these algorithms. If the individual does not find what the individual is looking for in the search results, the individual must refine the query by adding or modifying the search terms manually.

In addition to providing search results, the search engines usually present advertisements to the individual. These advertisements are typically selected based on the terms of the individual's query. For example, if the individual provides a query for a “new car,” a search engine can provide sponsored links, banners, or other types of advertisements that are generally related to automobiles. These advertisements may or may not be relevant to the individual, since the selection of the advertisements is selected based on the few search terms provided in the query.

### SUMMARY

Example embodiments described herein relate generally to systems and methods for aggregating, filtering and delivering online content.

In one aspect, a computing device that filters online content to be delivered to an individual includes a processor, and a computer readable storage medium storing instructions. When the instructions are executed, the computing device is caused to: receive content from a plurality of sources, and to index the content; receive input from the individual to indicate a relevance of certain of the content; filter the content based on the input from the individual and identify relevant content for the individual; and deliver the relevant content to the individual.

The summary is not intended to describe each disclosed embodiment or every implementation. The figures and the detailed description that follows describe further embodiments. While certain embodiments will be illustrated and described, the present disclosure is not limited to use in such embodiments.

### DESCRIPTION OF THE DRAWINGS

FIG. 1 shows an example computer system.

FIG. 2 shows an example program that allows an individual to discover and act upon information.

FIG. 3 shows an example user interface of the program of FIG. 2.

FIG. 4 shows an enlarged view of the user interface of FIG. 3.

FIG. 5 shows another view of the user interface of FIG. 3.

FIG. 6 shows another view of the user interface of FIG. 3.

FIG. 7 shows another view of the user interface of FIG. 3.

FIG. 8 shows another view of the user interface of FIG. 3.

FIG. 9 shows an alternative example user interface of the program of FIG. 2.

FIG. 10 shows another view of the user interface of FIG. 9.

FIG. 11 shows another view of the user interface of FIG. 9.

FIG. 12 shows another view of the user interface of FIG. 9.

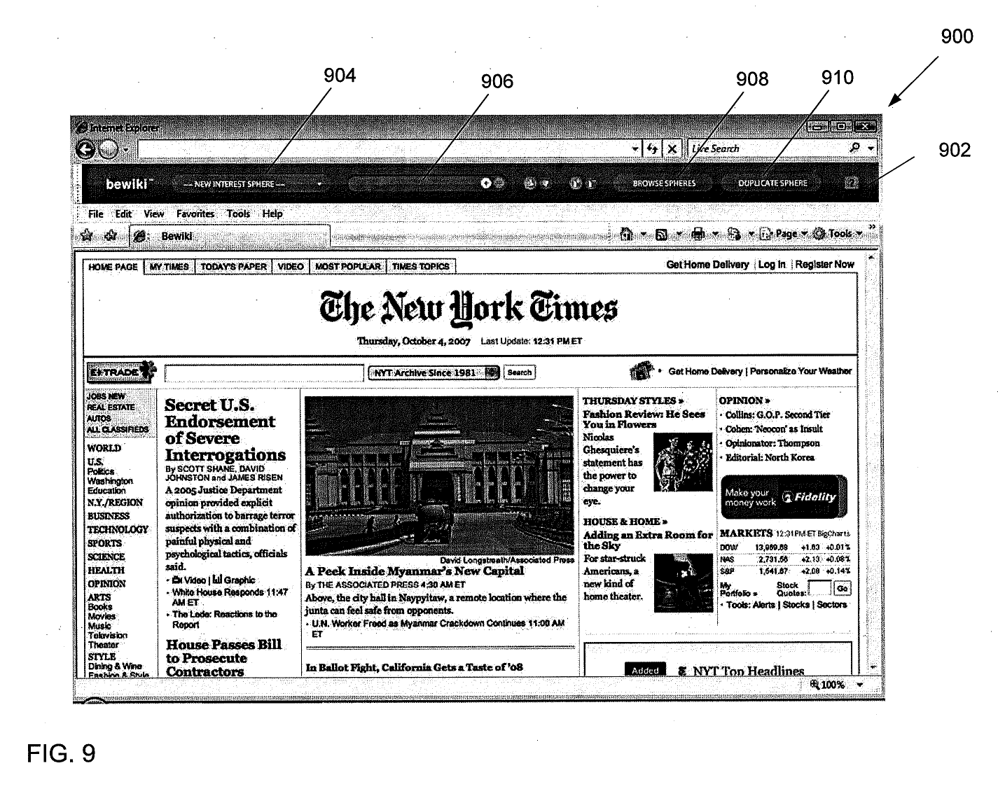

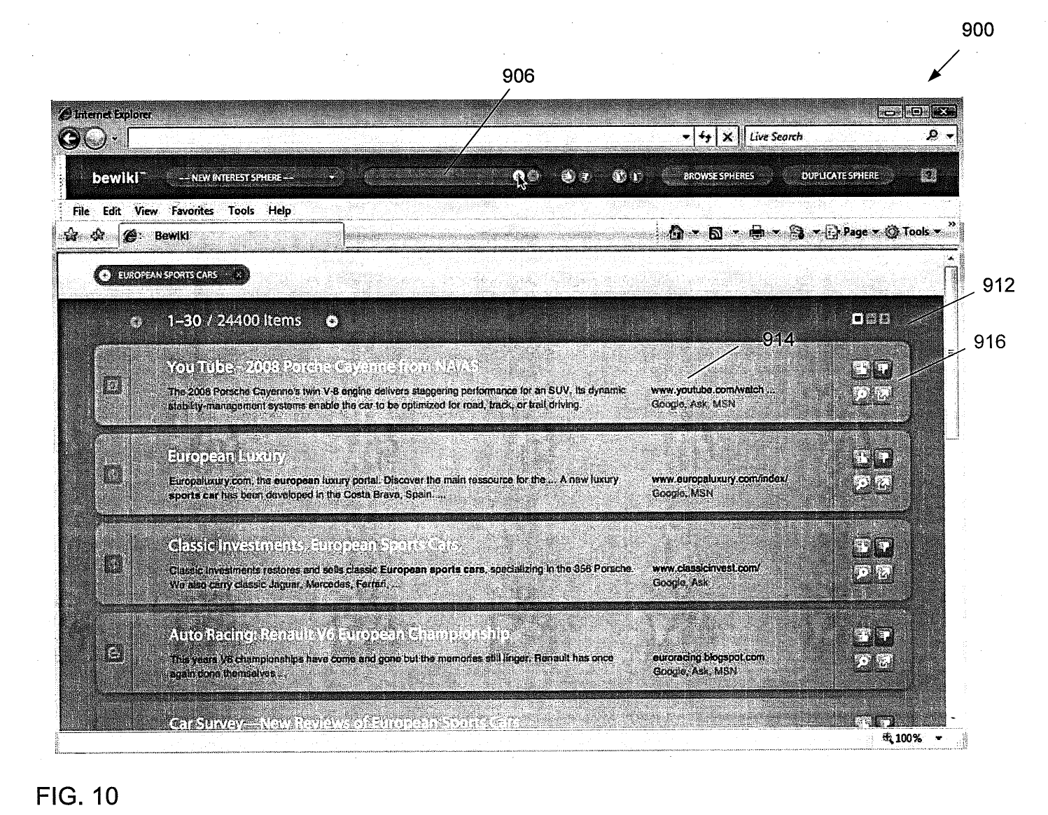

FIG. 10 shows another view of the user interface of FIG. 9.

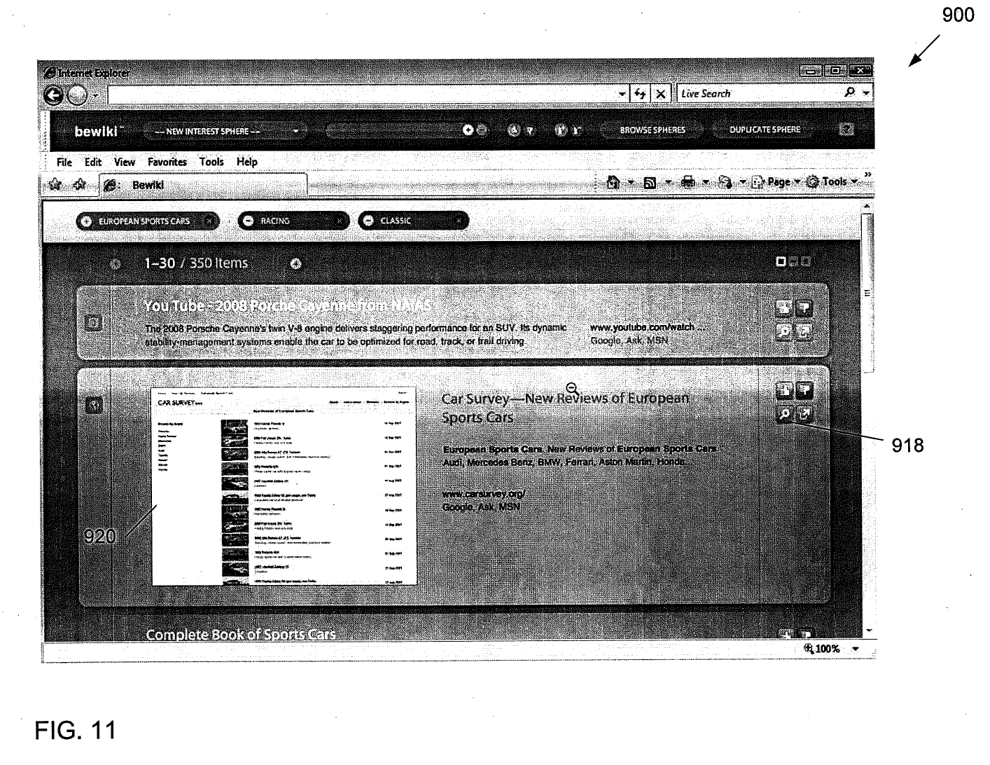

FIG. 11 shows another view of the user interface of FIG. 9.

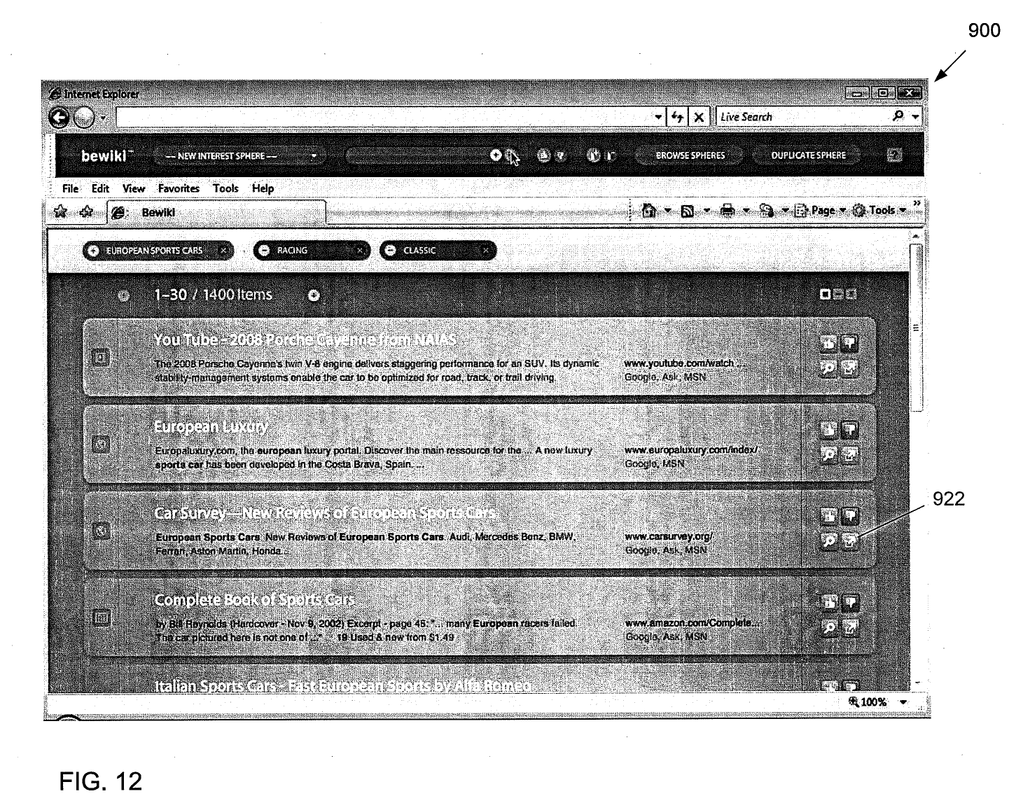

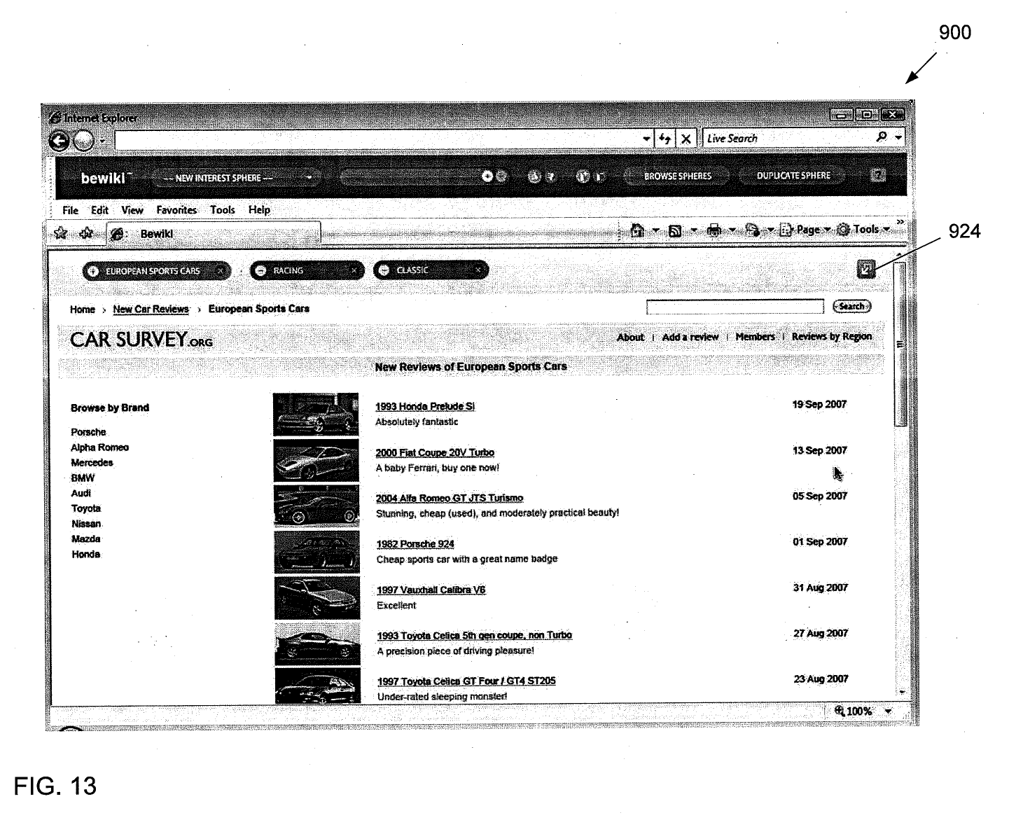

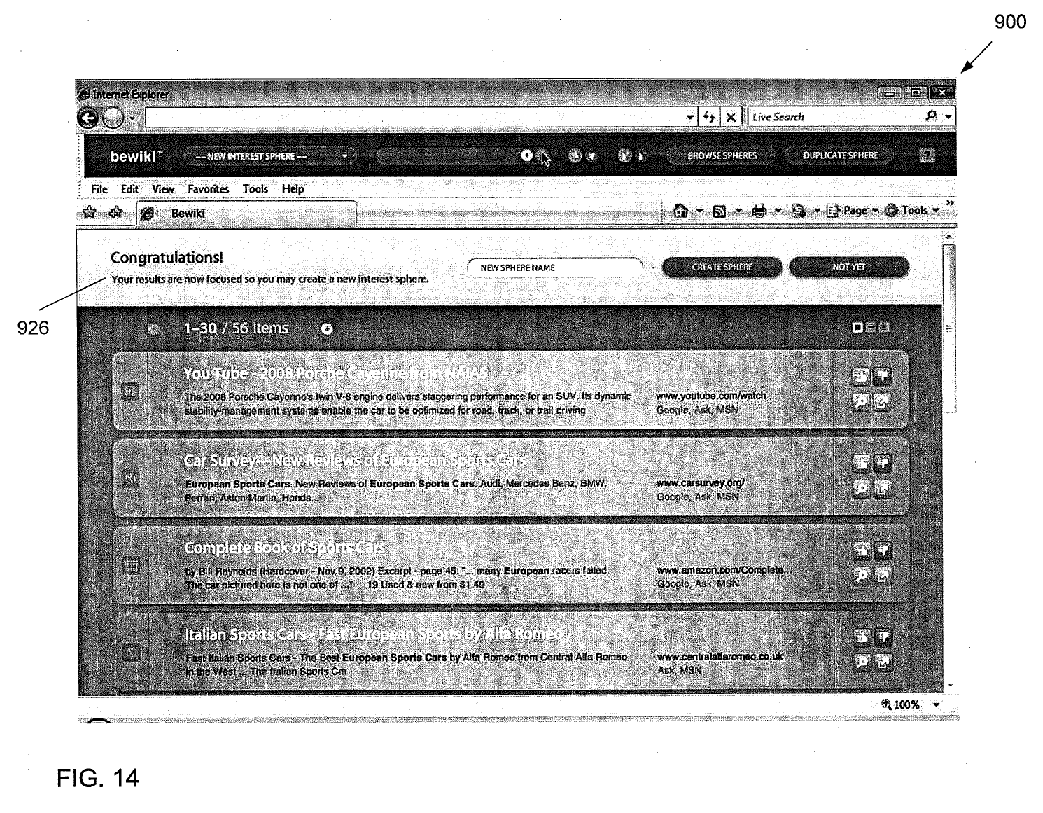

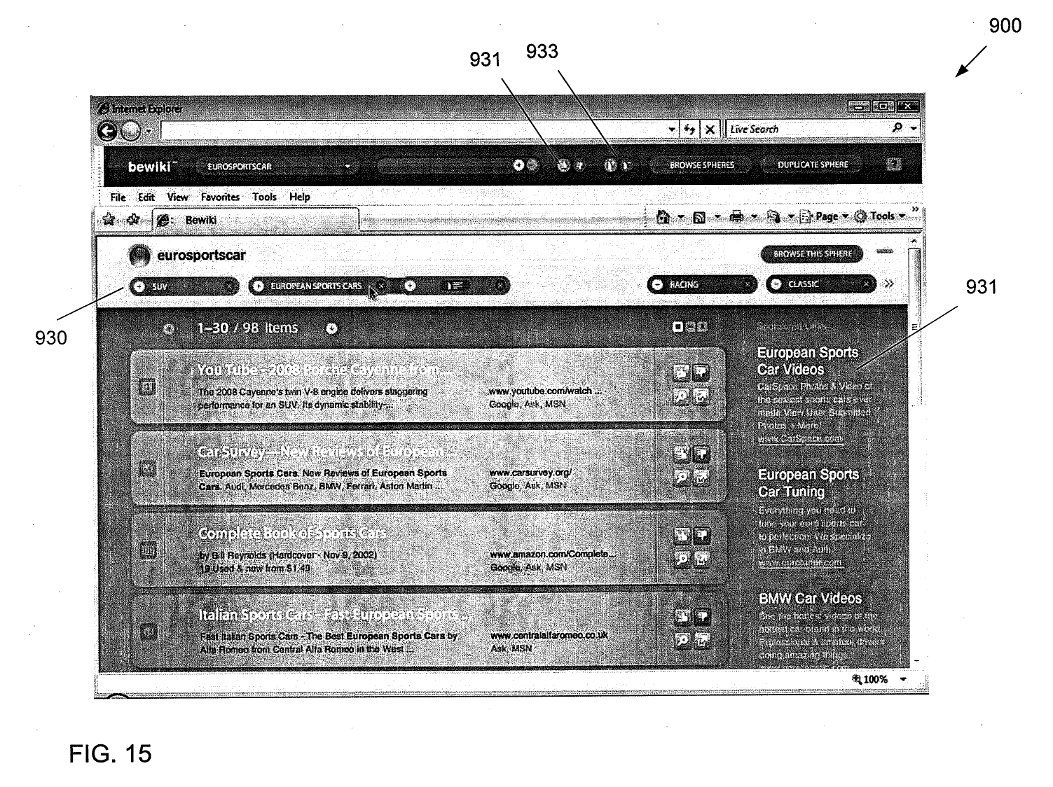

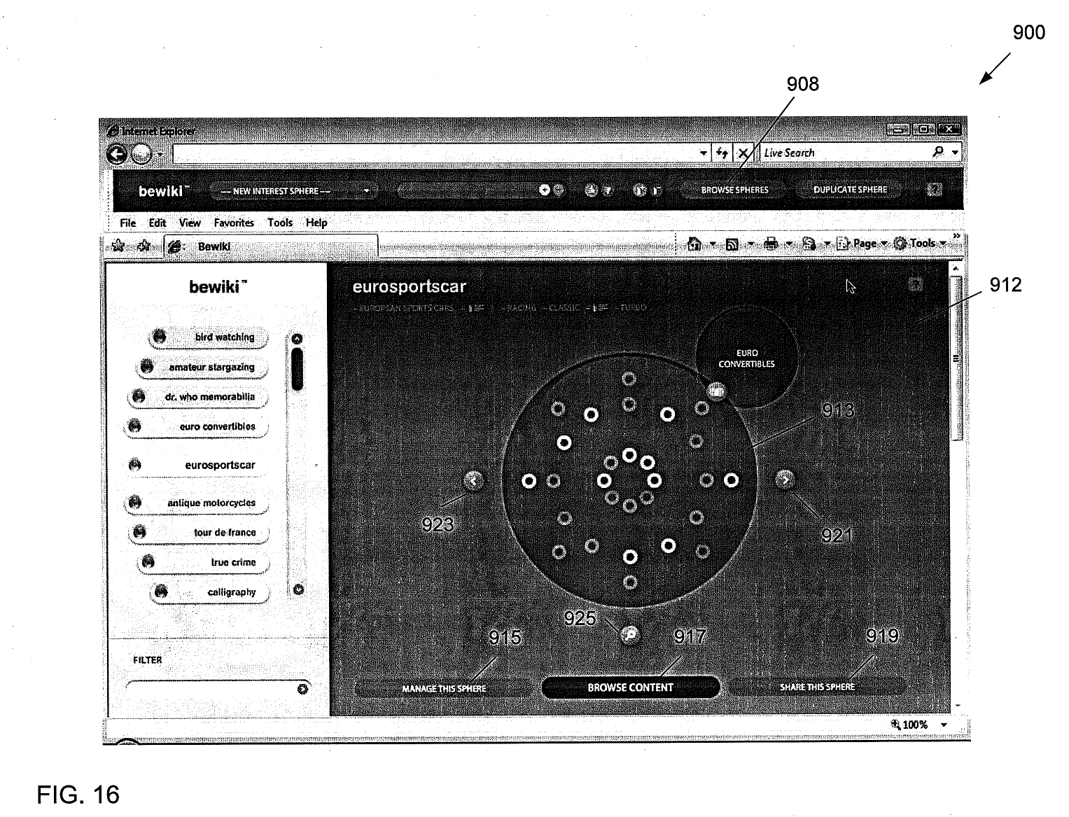

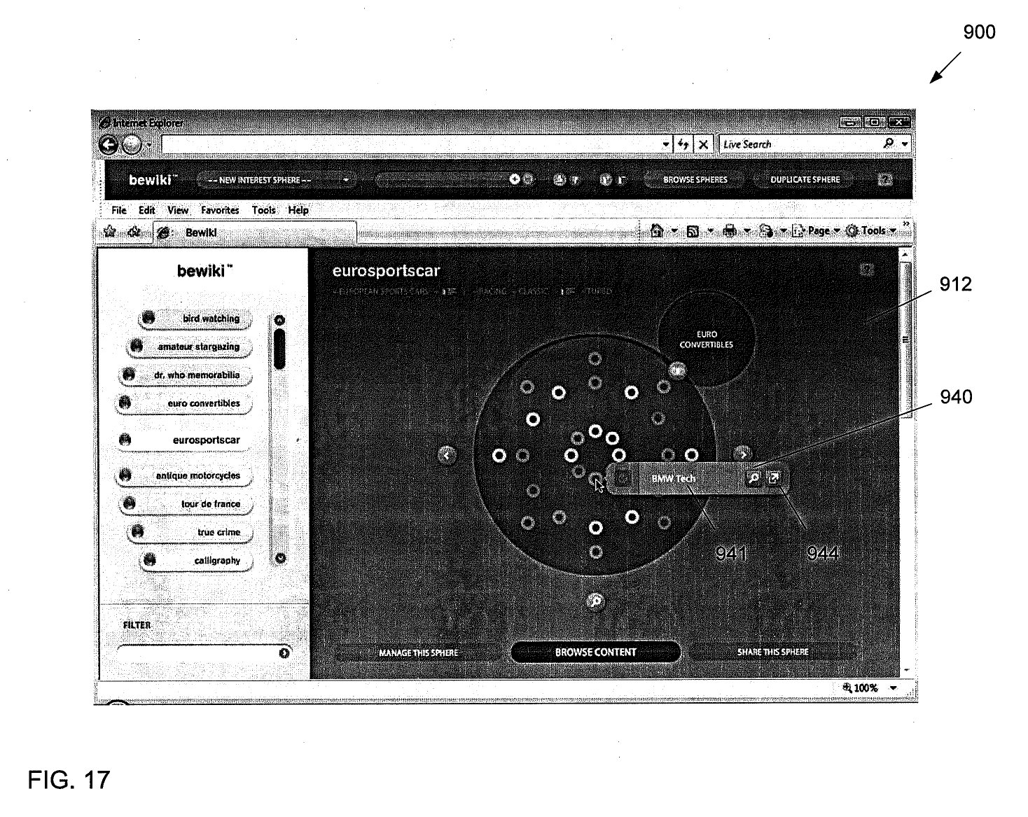

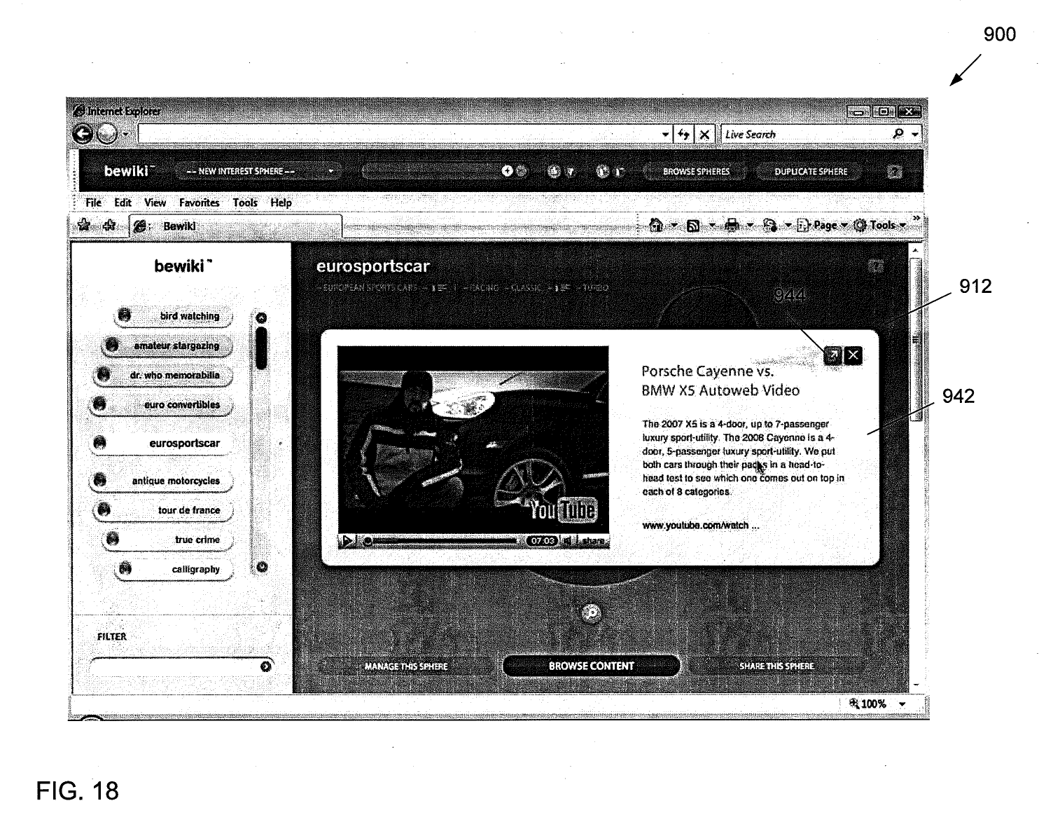

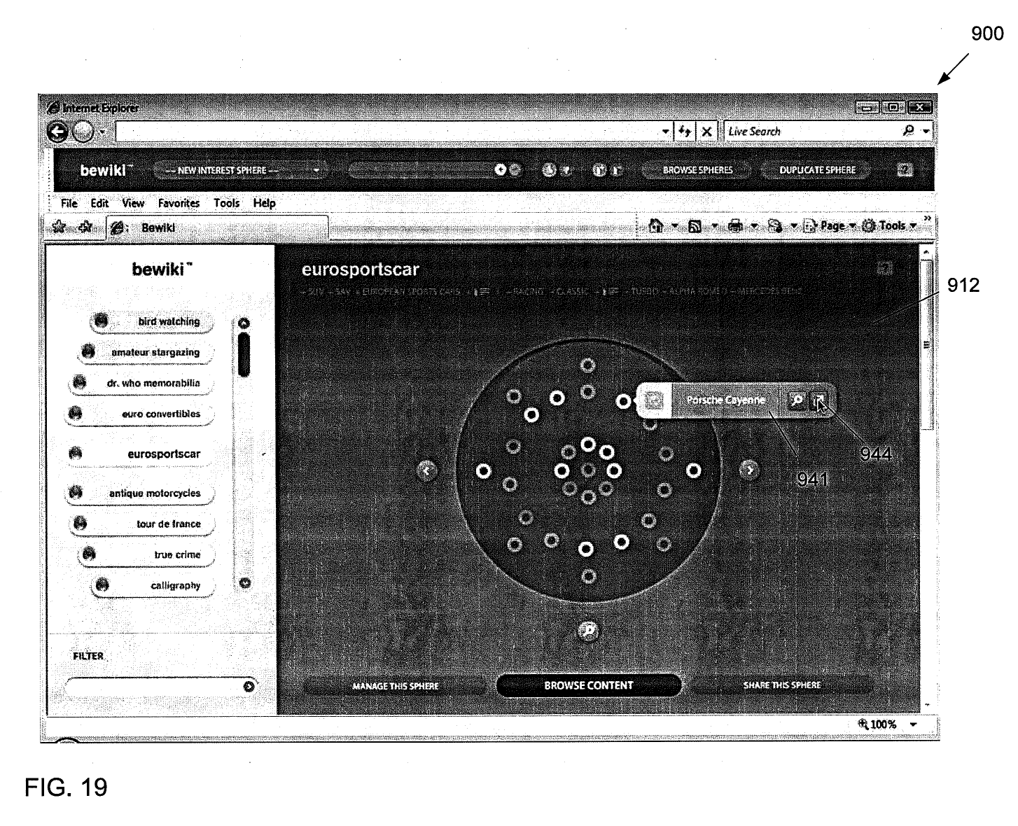

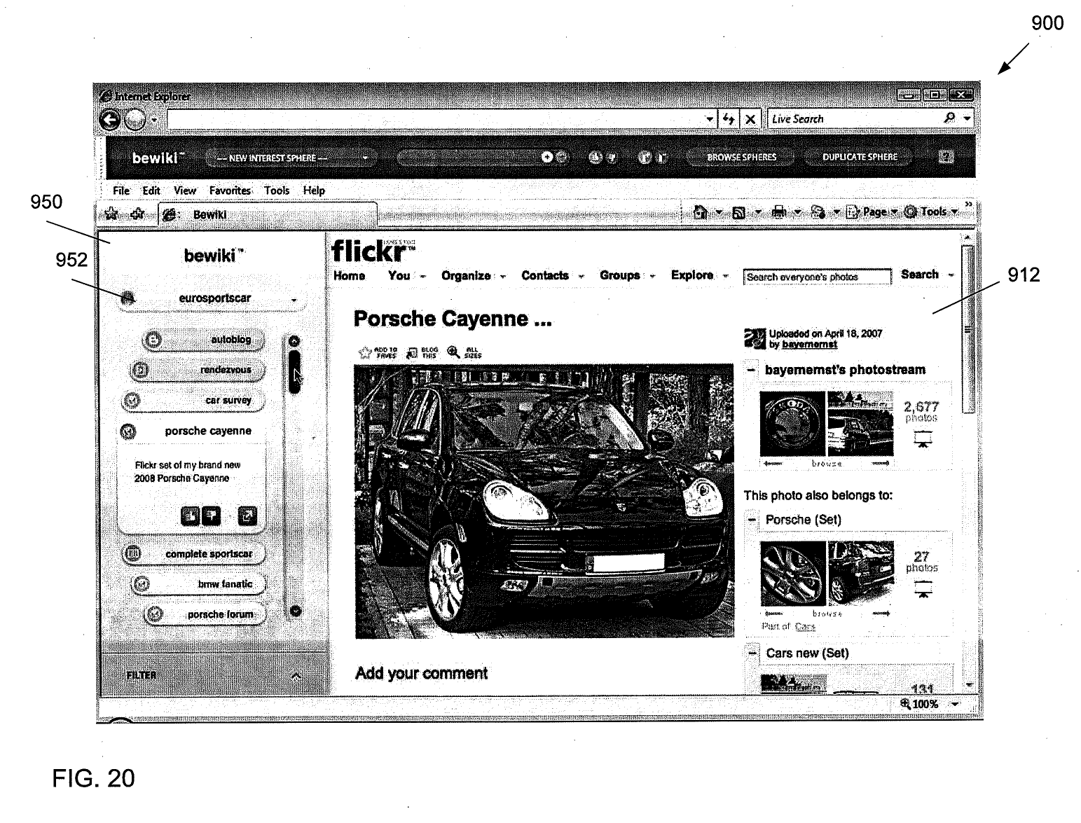

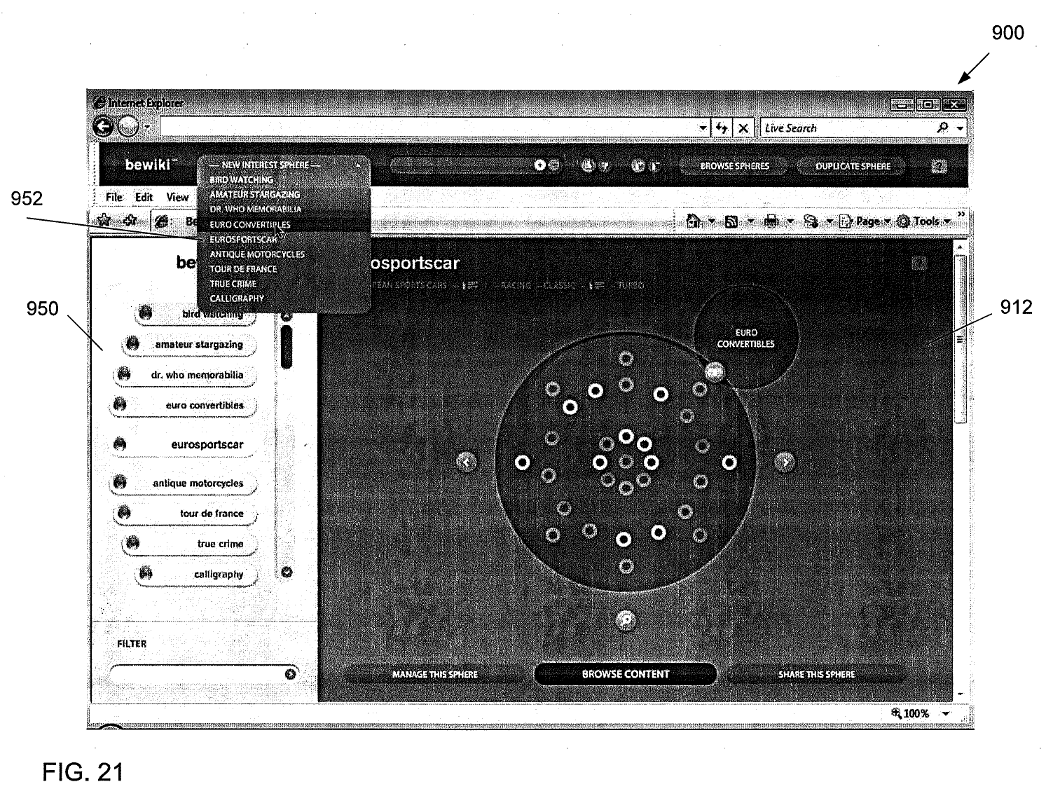

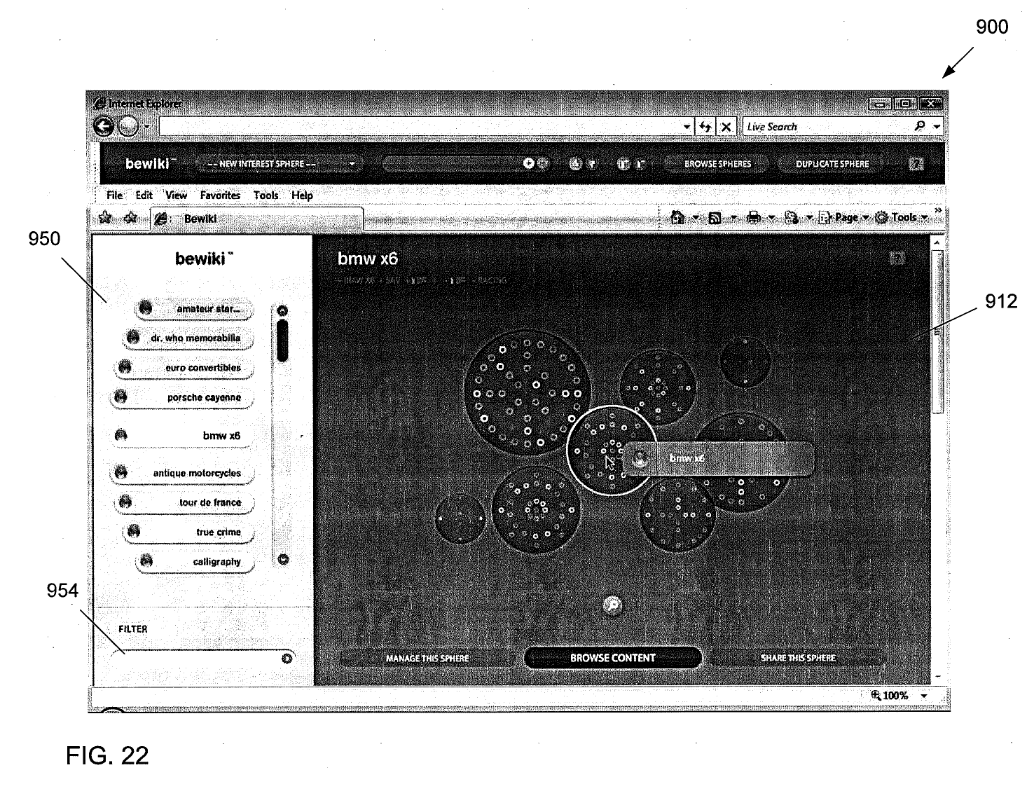

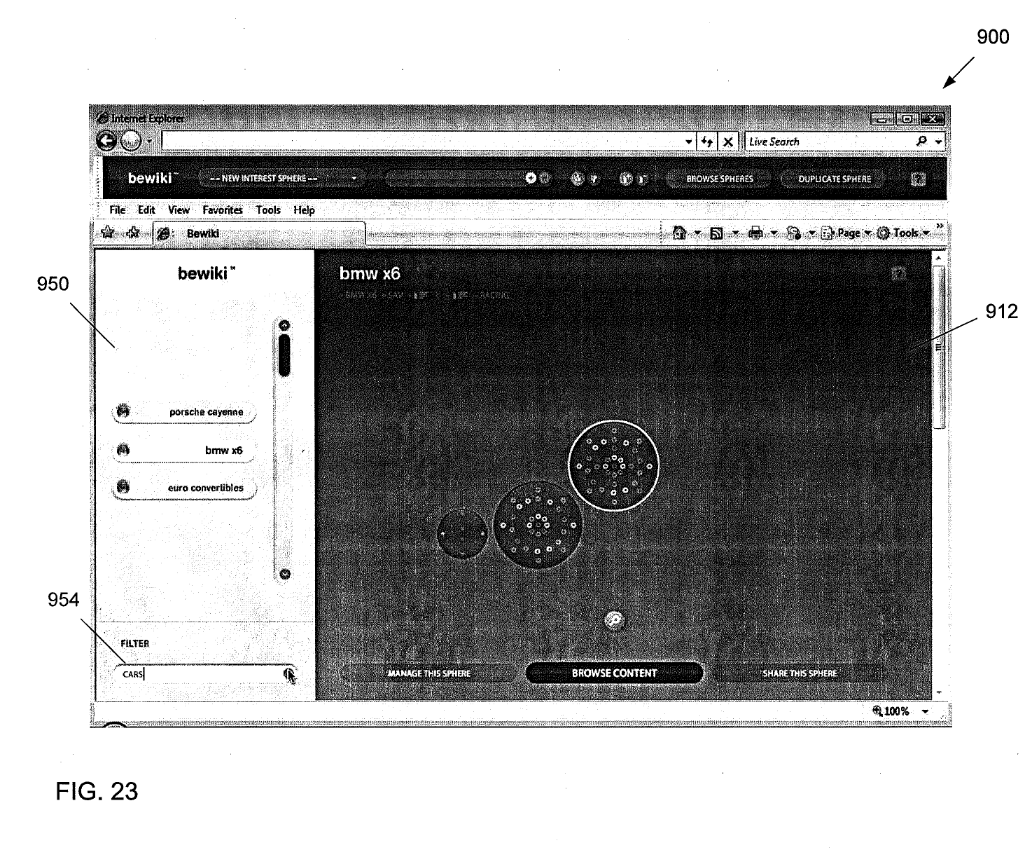

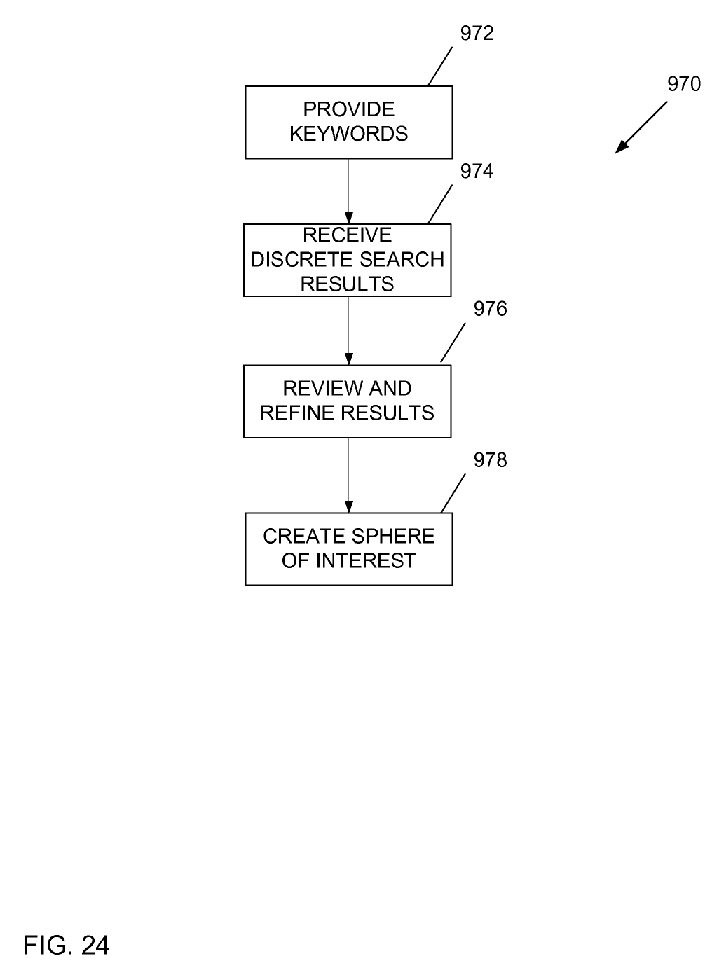

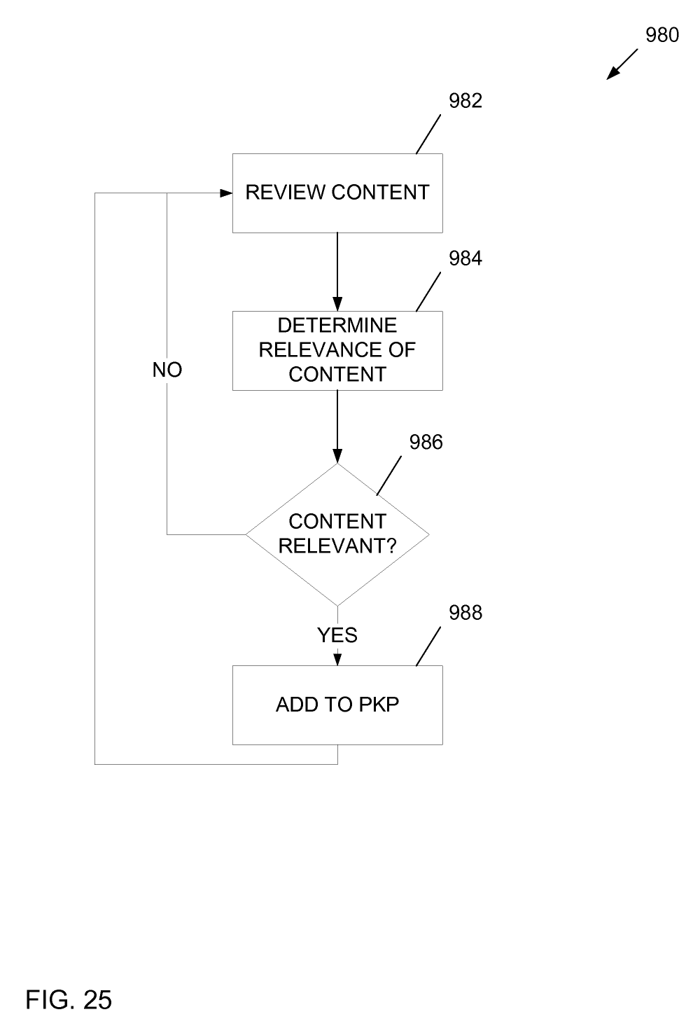

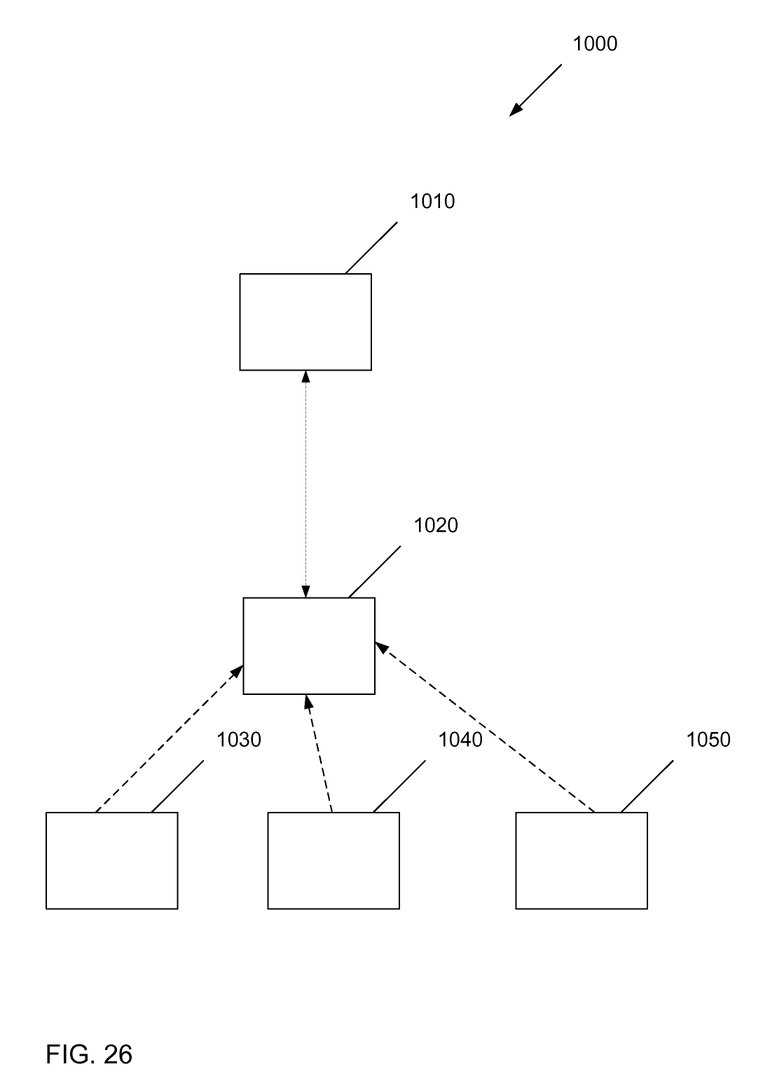

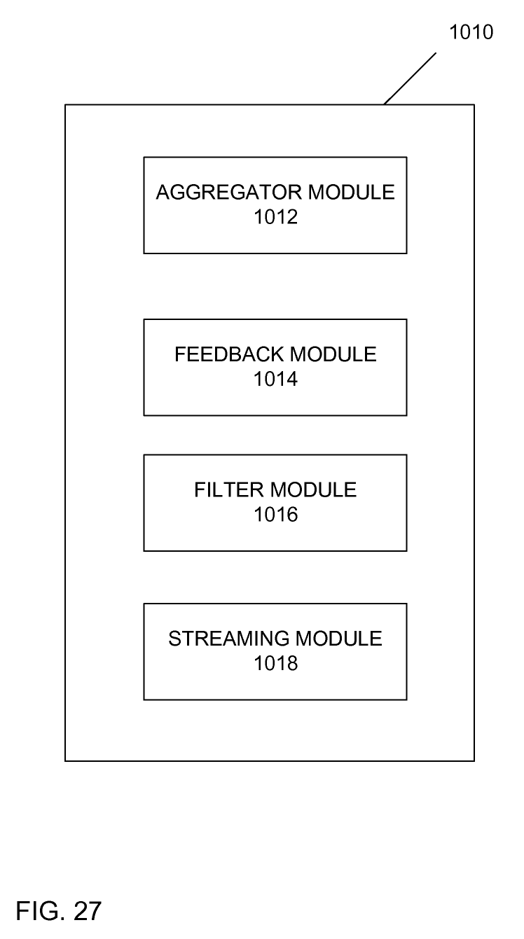

FIG. 12 shows another view of the user interface of FIG. 9.

FIG. 13 shows another view of the user interface of FIG. 9.

FIG. 14 shows another view of the user interface of FIG. 9.

FIG. 15 shows another view of the user interface of FIG. 9.

FIG. 16 shows another view of the user interface of FIG. 9.

FIG. 17 shows another view of the user interface of FIG. 9.

FIG. 18 shows another view of the user interface of FIG. 9.

FIG. 19 shows another view of the user interface of FIG. 9.

FIG. 20 shows another view of the user interface of FIG. 9.

FIG. 21 shows another view of the user interface of FIG. 9.

FIG. 22 shows another view of the user interface of FIG. 9.

FIG. 23 shows another view of the user interface of FIG. 9.

FIG. 24 shows an example method for creating an interest collection.

FIG. 25 shows an example method for analyzing content for inclusion in a personal knowledge profile.

FIG. 26 shows another example system.

FIG. 27 shows details of a central server of the computer system of FIG. 26.

### DETAILED DESCRIPTION

Reference is now made in detail to the example aspects of the present disclosure that are illustrated in the accompanying drawings. Wherever possible, the same reference numbers are used throughout the drawings to refer to the same or like structure.

Example systems and methods disclosed herein are generally directed to individual search technology. In example embodiments, an individual uses such individual search technology to discover (e.g., gather, organize), share, and act on information.

In example embodiments, the individual performs discrete searches based on search terms. The individual reviews the search results, and the system monitors the individual's interactions to develop a personal knowledge profile (PKP), sometimes referred to as a Personal Interest Profile (PIP). In some examples, the PKP or PIP is used to retain information related to the individual, such as preference information, search information, and other interactional information about the individual. The PKP or PIP can be used to filter further content that is provided to the user.

In one example, the PKP incorporates artificial intelligence that combines search technology with linguistic and mathematical algorithms to further discern and refine search concepts for the individual. The PKP provides context to the individual's searches and learns the individual's preferences over time. In addition, in some embodiments, the individual shares the PKP with others, as well as uses the PKP to enhance future searching by automatically generating rich queries and crawling the Internet to identify additional relevant information for the individual.

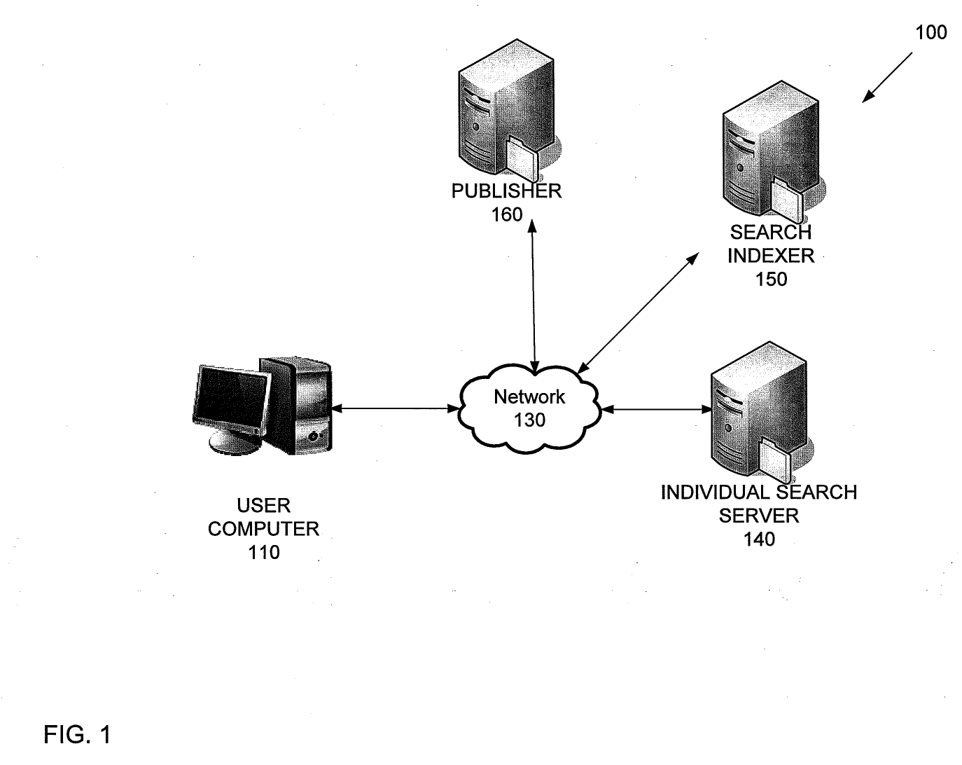

Referring now to FIG. 1, an example system 100 is shown. The system 100 includes a user computer 110 that is connected to a network 130. The network 130 of the system 100 is also connected to an individual search server 140, a search indexer 150, and a publisher 160.

In the example shown, the user computer 110 is a computer controlled by an individual. In general terms, the individual uses the user computer 110 to seek information from one or more sources connected to the network 130. For example, the individual can use the user computer 110 to search for topics of interest to the individual. In examples described herein, the topic of interest is European sports cars.

In example embodiments, the user computer 110 is a personal computer such as a laptop computer, a desktop computer, a Personal Data Assistant (PDA), or a handheld communication device such as a Smartphone or PocketPC. Other configurations are possible. The user computer 110 generally includes a processing unit and computer readable media. Computer readable media can include memory such as volatile (such as RAM), non-volatile (such as ROM, flash memory, etc.) or some combination thereof. Additionally, computer readable media can include mass storage (removable and/or non-removable) such as a magnetic or optical disks or tape. An operating system, such as Linux or Windows, one or more application programs, and other information such as databases can be stored on the mass storage device.

The user computer 110 is a computing device that includes input devices (such as a keyboard, mouse, microphone for voice recognition) and output devices (such as a monitor, printer, or speaker for voice synthesization). The user computer 110 also includes network connections to other devices, computers, networks, servers, etc., that are connected to the network 130. In example embodiments, the network 130 is a local area network (LAN), a wide area network (WAN), an intranet or extranet, or a combination thereof. Communications with the network 130 are implemented using wired and/or wireless technologies. Other configurations are possible.

In the embodiments disclosed herein, the individual uses the user computer 110 to access content hosted by one or more computers connected to the network. The content can be any data available through the network, such as web pages including text, graphics, and video. The content can also include documents and application programs. For example, the user computer 110 includes a web browser that uses known languages, such as hypertext markup language (“HTML”) and/or extensible markup language (“XML”), to communicate with the individual search server 140, the search indexer 150, and the publisher 160. One example of a browser is the Internet Explorer browser offered by Microsoft Corporation. Other types of browsers and configurations are possible.

The user computer 110 also communicates with the search indexer 150 through the network 130. In some embodiments, the search indexer 150 is a search engine that crawls the Internet and downloads and analyzes sites found on the Internet. The search indexer 150 allows individuals, such as the individual controlling the user computer 110, to submit a query in the form of search terms such as keywords or a phrase in Boolean expression or natural language to the search indexes in an attempt to locate desired information. Examples of search indexers include Google, Yahoo, MSN, and Ask.

The user computer 110 also communicates with the publisher 160. The publisher 160 publishes a web site or other online content. For example, the publisher 160 can be a web site that provides information about products, services, or other areas of interest. In some embodiments, the publisher 160 provides one or more web sites on a given topic. For example as described herein, the publisher 160 is a web site that has information about European sports cars.

In the embodiment shown, the search indexer 150 crawls the network 130 and identifies the web site for the publisher 160. The search indexer 150 crawls and indexes the web site for the publisher 160. The individual can send a query from the user computer 110 to the search indexer 150. Depending on the search terms used, the search results that are sent by the search indexer 150 back to the user computer 110 can include a reference to the web site of the publisher 160. The individual can then review the search results and select the reference to the publisher 160 to access the web site.

Still Referring to FIG. 1, in example embodiments described herein, the individual uses one or more programs on the user computer 110 to search for relevant content available on the network 130. To accomplish this, the user computer 110 communicates with the individual search server 140 through targeted paths on the network 130. In one example, the individual search server 140 includes one or more application programs that can be downloaded and installed onto the user computer 110. In other examples, all of the content can be stored on the search server 140.

In one example, the individual search server 140 can include one or more programs that are downloaded and installed on the user computer 110 to allow the user to discover and act on information. In example embodiments, the user computer 110 downloads the program using a known protocol such as HTTP or the file transfer protocol (FTP). Once downloaded, the individual installs the program on the user computer 110.

Generally, the programs allows the individual to perform discrete keyword searches, as well as to enhance the individual's search experience by developing a PKP that stores information specific to the individual. The PKP can be used to generate more relevant search results and to identify additional information that may be of interest to the individual.

In some examples, the program allows the individual to perform discrete searches using multiple sources of information and to develop the PKP on the user computer 110 (or on the server, in the case of the hosted design) that reflects the individual's searches and assists the individual in finding additional relevant information. These discrete searches can be done using traditional sources, such as search engines like Google and Yahoo. The search results are indexed, contextually analyzed (see below), stored in the PKP, and presented to the individual. Through further feedback from the individual, the search results are refined and additional sources of information are identified, as described below.

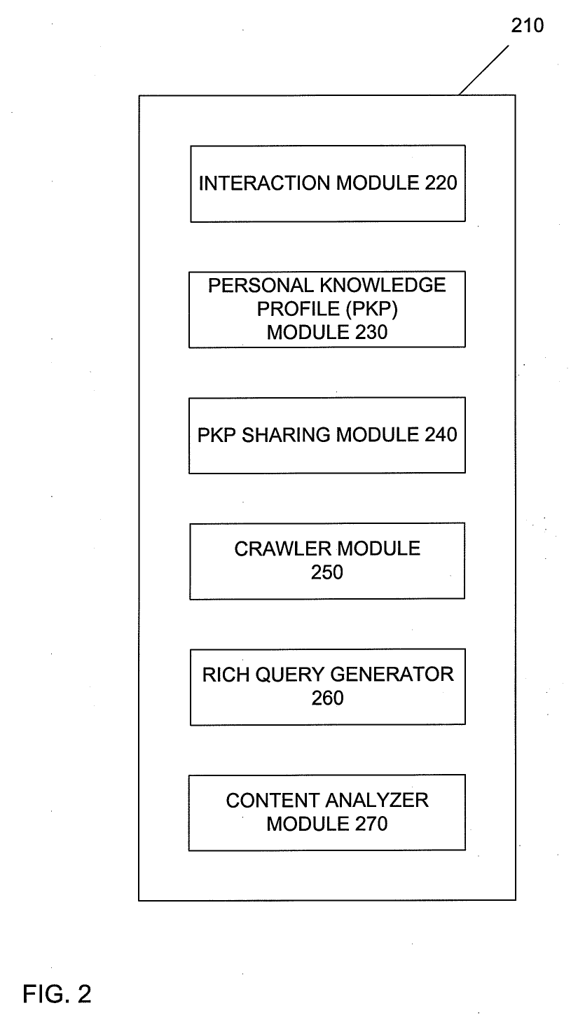

Referring now to FIG. 2, a logical representation of an example program 210 is shown. The program 210 enhances the individual's experience while searching for information available on the network 130. For example, the program 210 is programmed to analyze interaction and signals from the individual while the individual searches for and reviews information such as web sites using the user computer 110. Based on this analysis, the program 210 stores information associated about the individual's interests, as well as searches and presents additional information that is relevant to the individual's interests.

In example shown, the program 210 is downloaded and installed locally on the user computer 110. For example, the program 210 can be a stand-alone application or a plug-in for a web browser such as Internet Explorer. Since the program 210 is installed locally, all information collected about the individual that is stored in the PKP is also stored locally and can be protected by, for example, authentication and/or encryption, thereby enhancing privacy.

In alternative embodiments, the program 210 can be a hosted program running on a remote server, such as the individual search server 140. In such embodiments, the individual creates an account on the individual search server 140, and the account is protected by security measures such as a user name and password. A hybrid approach in which some components are installed locally on the individual's computer and others are hosted remotely is also possible. In other embodiments, information such as the PKP that is stored locally on the individual's user computer 110 can be synchronized and/or backed up on the individual search server 140. In this manner, the individual can transfer the individual's PKP to other computers and backup/restore the individual's PKP, if needed.

As shown in FIG. 2, the program 210 includes an interaction module 220, a PKP module 230, a PKP sharing module 240, a crawler module 250, and a rich query generator 260, and a content analyzer module 270.

The interaction module 220 is programmed to monitor the individual's interactions with search results and record feedback. This feedback can be explicit or implicit. For example, as described further below, the individual can indicate that certain content (e.g., a web page, document, product, event, and/or forum/community) in the search results is more or less relevant to the information for which the individual is looking. The individual can also highlight certain terms within the content to indicate that these terms are or are not relevant. In some embodiments, other behavioral cues are also monitored. For example, because the search tool 210 is installed locally on the user computer 110, the interaction module 220 can be programmed to monitor how long an individual views particular content to make a determination as to the relevance of the page. Other configurations are possible. The interaction module 220 is programmed to communicate the interaction information to the PKP module 230.

The PKP module 230 is programmed to store the implicit and explicit feedback from the interaction module 220. In example embodiments, the PKP module 230 includes a neural network and a relational database. In the example shown, the neural network is a linguistic network that includes multiple interpretation layers. These layers include a dictionary and define linguistic triggers and associations. The nodes of the neural network are thereby linguistically triggered by reacting to words and phrases. The relational database is programmed to store the states of the neural network in non-volatile memory. Other configurations are possible.

In the illustrate embodiment, the PKP module 230 organizes the individual's feedback into one or more interest collections. An interest collection is a collection of information about a particular interest of the individual. For example, if the individual has an interest in European sports cars, the individual can create an interest collection related to this topic. The information surrounding this interest collection is stored in the PKP module 230. As the individual uses the search program 210 to research European sports cars, the information from the individual (explicit and/or implicit) is captured in the interest collection.

In example embodiments, the search tool 210 prompts the individual to create an interest collection at a predetermined point. For example, the PKP module 230 is programmed to prompt the individual to create an interest collection once the individual has refined a particular search to a specific point, such as less than a threshold number of search results. For example, the threshold can be based on a relevancy determination within the neural network, such as by a determination of the volume of content in the particular interest collection. In other examples, the threshold is set at a given number of links within the interest collection, such as less than 1000 results, less than 500 results, less than 100 results, or less than 50 results. In other examples, the individual is prompted when the individual has reduced the relevant number of search results to a certain percentage from the original number of results, such as a 50%, 75%, or a 90% reduction. In yet other examples, the interest collection can be defined at the onset, or can be defined after a certain amount of time or number of times accessed or used by the individual. In alternative embodiments, the individual can manually define the interest collection before or after searches are performed. As described further below, the individual can access and review the contents of the interest collection, as well as review how a particular interest collection relates to other interest collections.

In the example shown, the PKP sharing module 240 allows the individual to share the contents of the individual's PKP module 230 with one or more other individual's that use the search program 210. For example, the individual can research information on a particular interest collection and then use the PKP sharing module 240 to share the information in this interest collection with another individual having the same interest and who is running the program 210 on the other individual's computer. In another example, the individual can obtain information from another individual's interest collection and incorporate this information into the PKP module 230 to allow the individual to benefit from the other individual's information. This sharing can be accomplished through various mechanisms, such as by defining an XML-based package that is downloaded and incorporated into the recipient's PKP module 230.

In some embodiments, the individual search server 140 maintains a centralized indexed list of the interest collections that individuals have chosen to share. The individual can search this list of interest collections and identify those interest collections in which the individual is interested. Once identified, in some embodiments the individual can download the contents of the interest collection from the individual search server 140, or can contact the owner to request the interest collection.

In yet other embodiments, the interest collections that are shared are centralized and combined with information from other individual's databases to form a centralized search repository on the individual search server 140.

The system also allows for individuals to network with other users of the system, if desired. For example, the individual can search for other individuals who have the same or similar interest collections. The individual can then communicate with others of similar interest, forming communities and sharing the information in the individual's PKP related to the interest collection. The individual can participate in online community environments such as chat sessions and forums devoted to the particular interest collection. As part of this participation, the individual can create an avatar (i.e., a graphic identity selected from a group of choices or created on by the individual represent the individual to others in a chat, instant messaging (IM) or multiplayer gaming session). This avatar can be used when the individual interacts with others in the system. The individual can purchase different attributes for the avatar that can change the look of the avatar.

In some embodiments, the individual controls how the individual's personal information is shared. For example, the individual decides whether or not to share information associated with the individual's PKP and interest collections. In other embodiments described further below, personal information is only shared with advertisers in an individual advertising arrangement so that the individual decides whether or not to provide information to the advertisers. In yet other embodiments, some non-personal information is shared so that targeted advertisements can be displayed that are meaningful for the individual.

The crawler module 250 is programmed to actively seek additional information related to an interest collection defined in the PKP module 230. In some embodiments, the crawler module 250 is programmed to crawl the most relevant content (e.g., one or more of the most highly-rated content) in a particular interest collection. The crawler module 250 can be programmed to “spider” a certain number of the highest ranked search results in an interest collection, identify new pages that are contextually relevant, and present the new pages to the individual, as described below.

The crawler module 250 can be “primed” by allowing the crawler module 250 to crawl a certain number of the search results, or a particular authority on a subject. For example, the crawler module 250 can be programmed to crawl a Wikipedia page associated with the individual's interest collection. As the crawler module 250 finds relevant content (e.g., web pages, blogs, RSS feeds, news groups, etc.), the content is indexed, analyzed, presented to the individual, and stored in the PKP module 240.

In some embodiments, the crawler module 250 can also be programmed to crawl the individual's own data storage devices to index the individual's own content. This content can also be added to the PKP module 240, if relevant.

In example embodiments, the crawler module 250 is programmed to run at a particular time (e.g., at night or other times) such that the crawler module 250 does not decrease performance of the user computer 110. In other examples, the crawler module 250 is programmed to use only a specified amount of resources. In addition, the crawler module 250 can be configured to define how deeply the crawler module 250 crawls. In some examples, the crawler module 250 is automatically started at periodic intervals once the individual defines an interest collection. In other examples, the individual can manually start and stop the crawler module 250.

Still referring to FIG. 2, the rich query generator 260 is programmed to leverage the information in the PKP module 230 to allow the program 210 to automatically generate rich queries based on the PKP module 230.

For example, in one embodiment, the rich query generator 260 is programmed to generate an XML-based query according to a predefined set of parameters and to forward this rich query to a third-party provider of content. The third party uses the rich query to generate a response that is meaningful to the individual. For example, the third party can be a provider of goods or services. The rich query provides the third party with more parameters so that the third party can respond to the individual with information that is relevant to the individual. In some examples, the individual can be prompted if additional parameters not found in the PKP module 230 are necessary so that the third party can be provide the individual with information related to relevant goods or services.

For example, the rich query can be formatted in XML based on the specification agreed-upon by a provider of a good, such as a European sports car manufacturer. An XML schema is defined including parameters relevant to automobile selection, including make, model, color, number of doors, etc. When the individual visits the manufacturer's web site, the rich query is generated from the PKP module 230 and is mapped to the XML specification and delivered to the web site of the manufacturer to allow the manufacturer to present a web page that is relevant to the individual. For example, if the individual defines an interest collection related to sports cars and searches for red sports cars with T-tops, this information is automatically sent to the sports car manufacturer so that, when the individual visits the sports car manufacturer's web site, the web page that is provided to the individual relates to sports cars that are red and have T-top options.

In other embodiments, the rich query is used to present advertisements to the individual within the program 210. The rich query is generated by the rich query generator 260 and is sent to the individual search server 140. The individual search server 140, in turn, uses the rich query to identify and send back to the individual advertisements that are meaningful to the individual. As described further below, these advertisements can be presented to the individual within the program 210. For example, advertisements for European sports cars of a particular model and make can be presented to the individual as the individual browses the interest collection regarding European sports cars.

In some embodiments, the XML schemas for such rich queries are agreed upon on an industry or site specific basis so that the exchange of information between the individual's PKP module 230 and the third party is optimized. For example, the automobile manufacturing industry can agree upon a standard XML schema to define the different attributes of an automobile so that a rich query that is sent to an automobile manufacture can be populated with information to allow the manufacturer to provide the most relevant information to the individual.

In some embodiments, the rich query generator 260 includes a transformation module into which a plug-in is installed. The plug-in acts as a translator that takes information from the PKP module 230 and translates the information into the appropriate XML structure so that a rich query can be sent to a third party. If new XML schema specifications are developed, additional plug-ins can be added to perform the required translations. For example, one or more application programming interfaces (APIs) can be provided to allow third parties to define translators so that a rich query can be formed and sent to third party content providers. In another alternative, the translation can be done on the remote third-party site. In such an example, the rich query generator 260 is programmed to define a rich query according to a certain specifications, and the third party that receives the rich query can translate the query as appropriate to use the contents of the rich query.

The content analyzer module 270 analyzes new content located from sites accessible on the network 130 to determine if the content is relevant to one or more of the interest collections in the PKP module 230. For example, as described above, as each search result is reviewed by the individual and given a positive or negative rating, the contents of the page associated with the search result is analyzed. During analysis of the page, the content of the page is converted to structured data (e.g., plain text including one or more headings or parts), and the data is stored in the individual's PKP module 230. This analysis includes linguistic and neural analyses that help the program 210 to determine the content of a particular page and match the content to the individual's preferences so that the program can deliver more relevant information to the individual.

In one embodiment, the content analyzer module 270 communicates with the crawler module 250 to index and analyze new content located by the crawler module 250 as the crawler module 250 crawls the most relevant pages in the interest collection. As new content is found, content is converted to structured data, and the content analyzer module 270 analyzes the content. If the content analyzer module 270 determines that the content is relevant to the interest collection, the content is added to the interest collection in the PKP module 230, and the individual can be alerted regarding the new content.

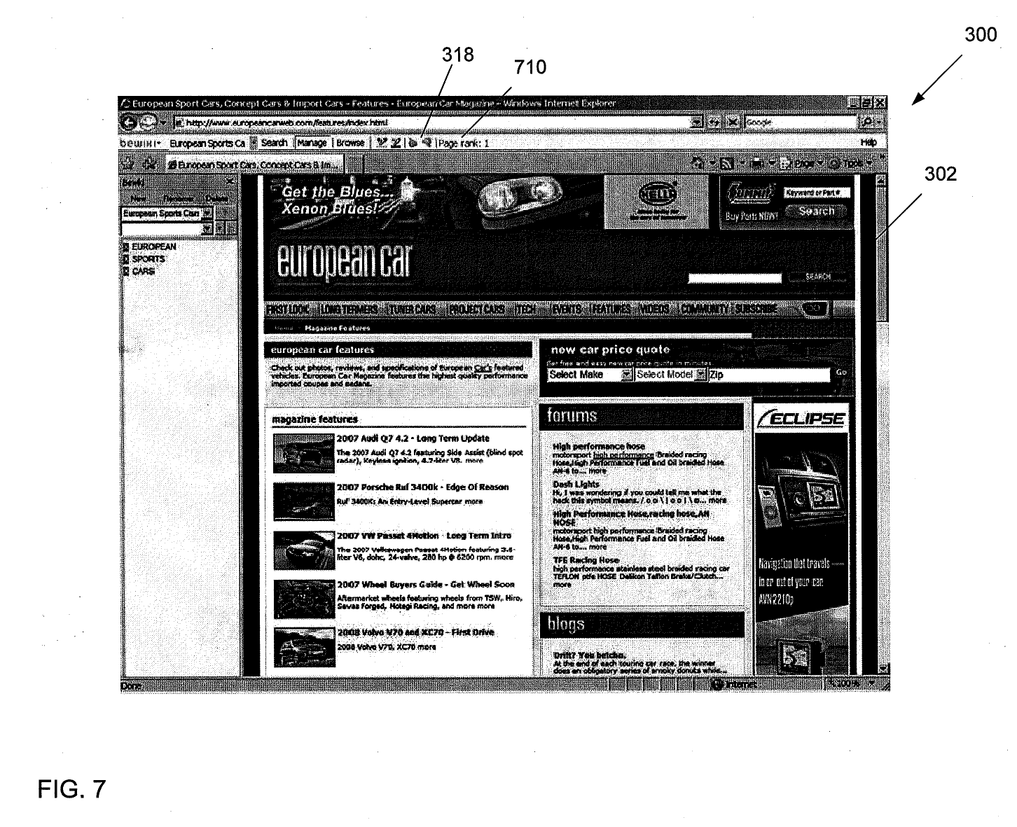

In an alternative embodiment, the content analyzer module 270 is programmed to review content on the fly as the individual browses the content and to provide the individual with an indication as to the relevance of the content to the individual's interest collection. For example, as the individual browses to a web page, the content analyzer module 270 automatically converts the content of the web page to structured data, analyzes the data with respect to the information in the PKP module 230, and provides the individual with a score indicating the relevance of the content to the interest collection. See FIG. 7 described below. In some embodiments, this analysis can be done almost instantaneously (e.g., within 1, 3, or 5 seconds) so that the individual can almost immediately see the relevance of page before reading it. This relevancy determination can be based on one or more of pattern recognition that accounts for the entire two-dimensional layout of the data including text and graphics, or a contextual analysis. The indications can be visual, such as a fuel gauge, a numeric number range (e.g., 1-10 or 1-5), a number of stars, or even an audible indication such as a number of beeps depending on relevancy. In some embodiments, the content analyzer module 270 can also provide an indication as to which interest collection the page is most relevant (assuming that the individual has defined multiple interest collections). In alternative embodiments, the content analyzer 270 can be programmed to pre-fetch links and analyze the content located through those links so that a relevancy score can be provided if the individual access those links. Other configurations are possible.

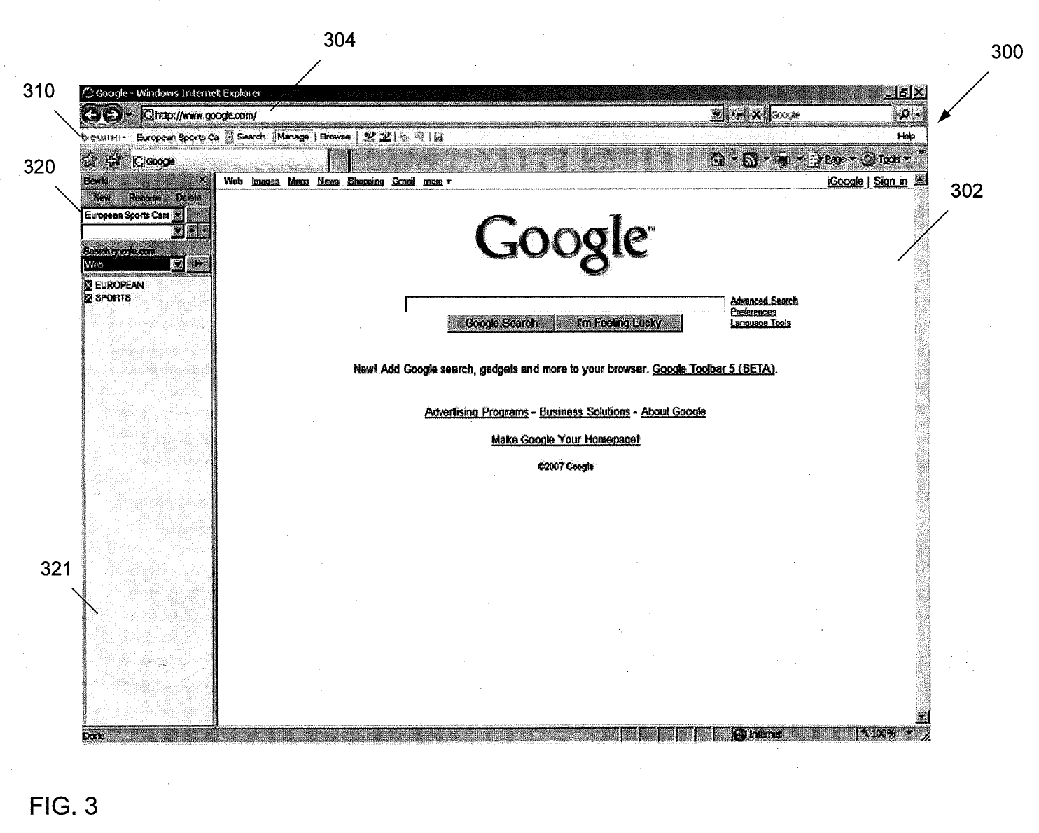

Referring now to FIG. 3-8, one example user interface 300 for the program 210 is shown. In the embodiment shown, the user interface 300 is provided as a toolbar plug-in for a browser such as Internet Explorer or Firefox. In alternative embodiments, the program 210 can be an application that runs separately from a browser.

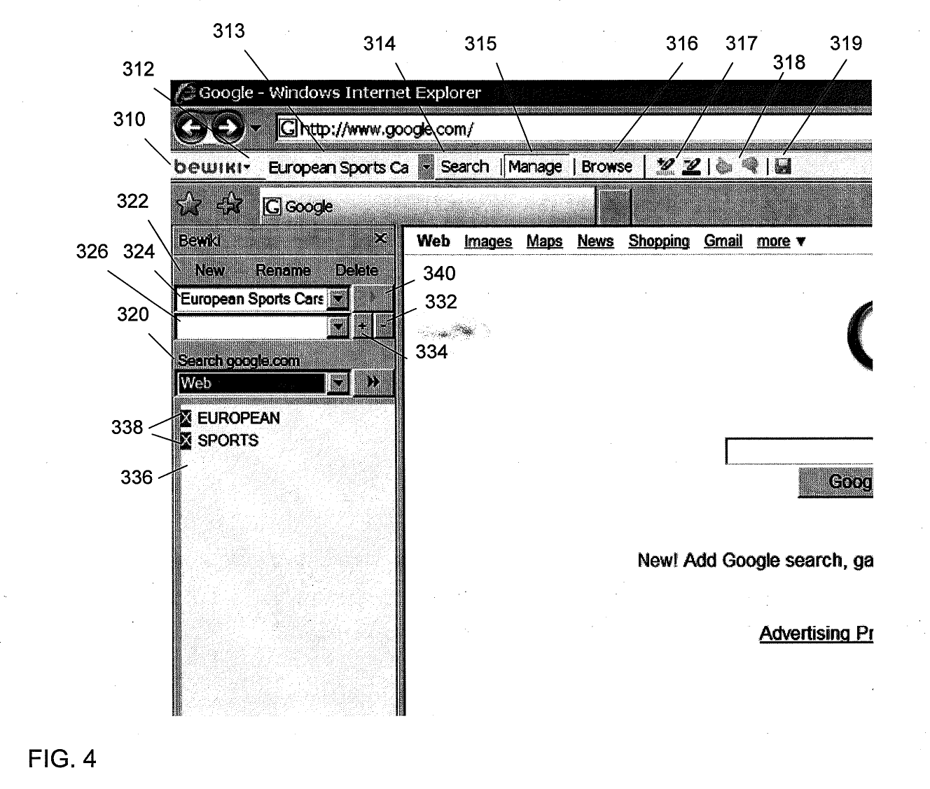

As shown in FIGS. 3 and 4, the user interface 300 is illustrated. includes a typical browser window 302 in which a web page is displayed. The user interface 300 generally includes a virtual computer in the form of a browser window 302. The user interface 300 also includes a user control area in the form of an address bar 304 into which a desired uniform resource locator (URL) can be entered. The user interface 300 further includes a search center 320 that allows the individual to discover and act on information. As shown, these components are provided as part of a typical browser, although other configurations are possible.

The user interface 300 also includes a toolbar 310, which is shown in greater detail in FIG. 4. The toolbar 310 includes a dropdown 312 that allows the individual to select among a plurality of search indexers. In the example shown, the individual can select between Google, Yahoo, MSN, and Ask. In some embodiments, additional search indexes can be added by the individual, if desired. For the example shown in FIGS. 3-8, Google is selected as the search index. In alternative embodiments described below, the individual can select multiple search indexers to perform a metasearch as well.

The toolbar 310 includes a dropdown 313 from which the individual can select one or more of the interest collections that have been defined by the individual. In the example shown, the interest collection selected is “European Sports Cars.”

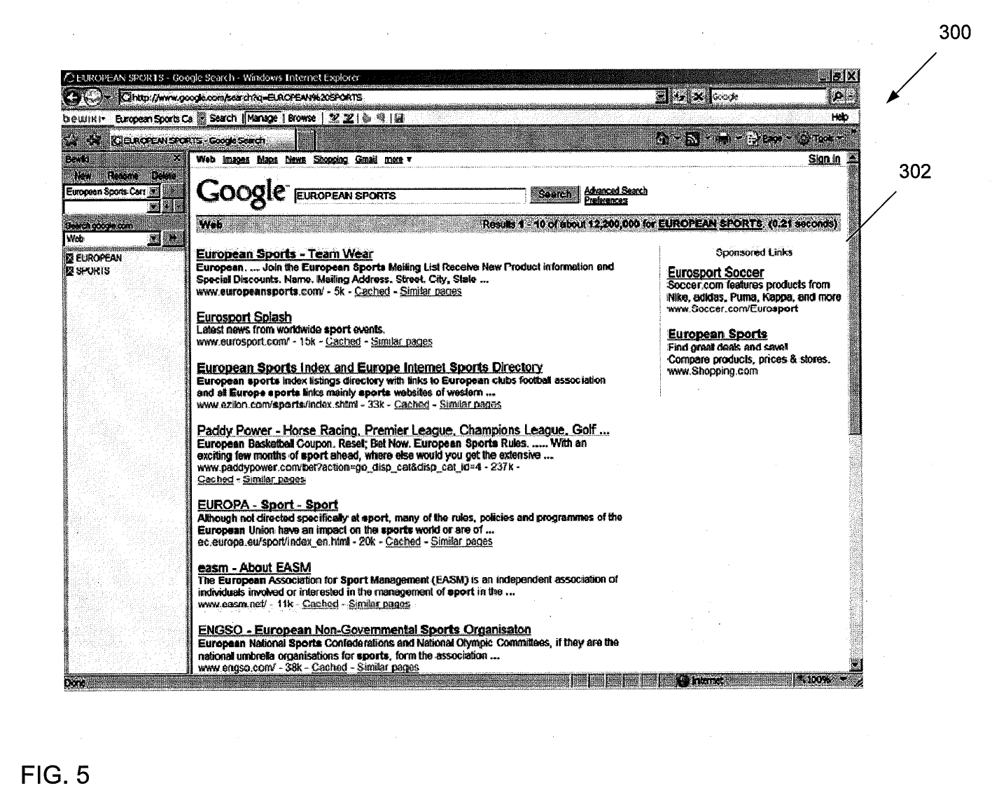

The toolbar 310 also includes a search button 314 that, when selected, causes a search query to be sent to the selected search indexer (see FIG. 5). The toolbar 310 includes a manage button 315 that exposes the search center 320 when pressed, and hides the search center 320 when pressed again.

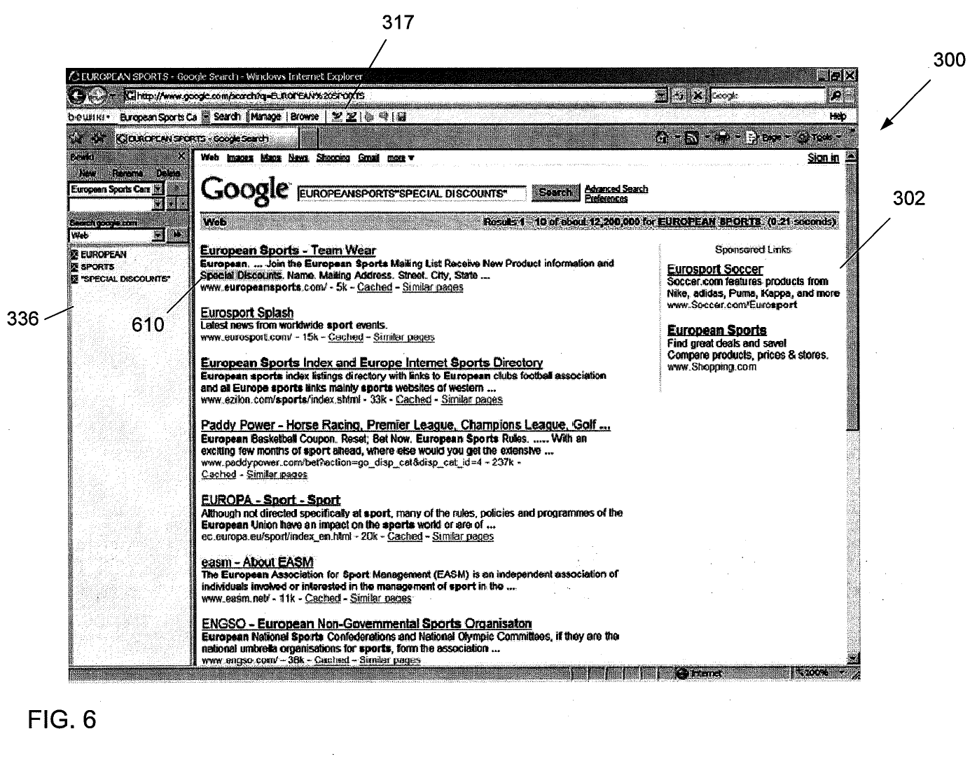

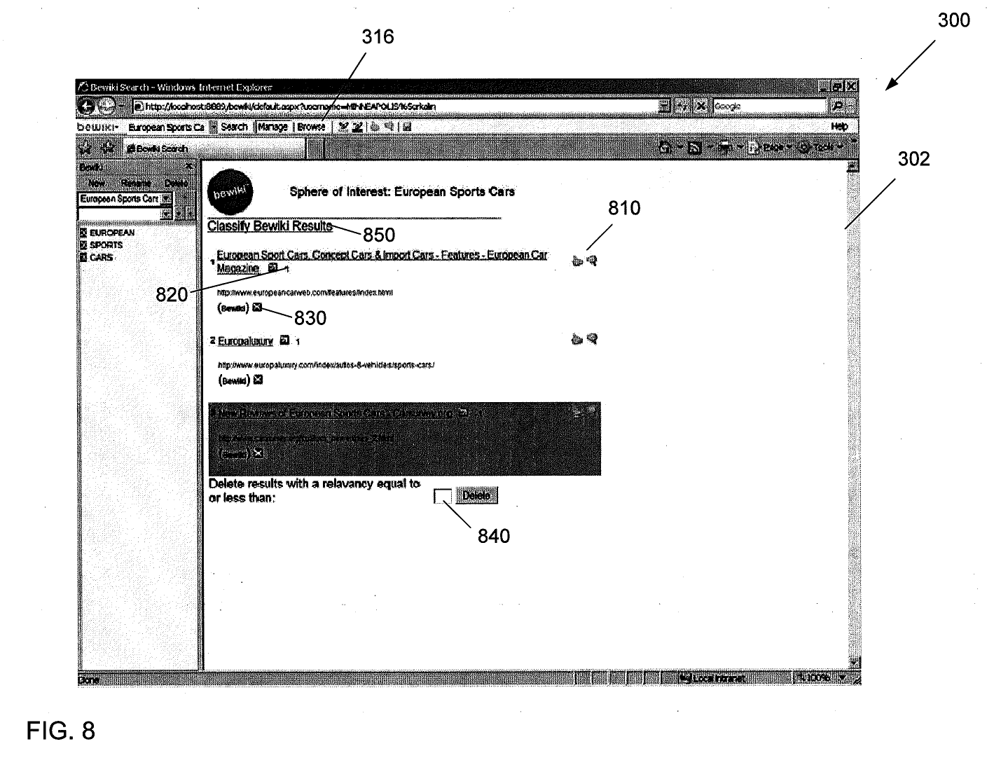

The toolbar 310 includes a browse interest collection button 316 that, when pressed, exposes the content of the selected interest collection (see FIG. 8). The toolbar 310 also includes highlighting buttons 317 and page relevance buttons 318 that allow the individual to provide feedback regarding the relevance of search results and content (see FIGS. 6 and 7). Also, the toolbar 310 includes a save button 319 that allows the individual to save the currently-displayed content to the interest collection.

The search center 320 includes a menu 322 that allows the individual to start a new interest collection, rename an interest collection, and delete an interest collection. A dropdown 324 allows the individual to select among the different interest collections.

The search center 320 includes a search box 326 into which the individual enters search terms for discrete searches. Once a keyword is entered into the search box, the individual selects a negative button 332 to add the keyword (or phrase) to the query as a negative term, or a positive button 334 to add the keyword to the query as a positive term. Once one of the negative or positive buttons 333, 334 is selected, the keywords are added to a query window 336. Each entry in the query window 336 includes a remove icon 338 associated with the entry that, when selected, removes the keyword from the query window 336.

In some embodiments, an advertisement portion 321 of the search center 320 can be used to deliver advertisements to the individual. The advertisement portion 321 can be programmed to display advertisements requested by the individual and/or advertisements identified based on one or more of the individual's interest collections, as described below. In the example shown, the advertisement portion 321 is persistent throughout the interface 300 so that advertisements can be displayed as the individual performs discrete searches, refines the search results, defines and refines the individual's interest collections, and browses the web. In some embodiments, the advertisements are modified depending on the particular interest collection that is shown in the browser window 302. Other configurations are possible.

Referring now to FIG. 5, once the desired keywords or phrases are added to the query window 336, the individual selects either an enter button 340 or the search button 314 to send the search terms to the selected search indexer. In the example shown, the keywords “European” and “Sports” are sent to the selected search indexer Google. In an alternative embodiment, the program 210 can automatically select among the different search indexers depending on the format of the query. For example, if the query is expressed as a plurality of keywords in a Boolean expression, the program 210 can send the query to a search indexer with an index optimized for such a query, such as Google. If, on the other hand, the query is natural language-based, the program 210 can send the query to a search indexer such as Ask. Other configurations are possible.

Once the query is sent to the search indexer, the search results from the query are displayed in the browser window 302.

Referring now to FIG. 6, the individual uses the toolbar 310 to provide feedback as the individual reviews the search results in the browser window 302. In the example shown, the individual selects the positive button from the highlighting buttons 317, and then uses the cursor to select the text 610 (“Special Discounts”). Once this text is selected, the text is highlighted (e.g., green for positive, or red for negative), and the text is sent to the query window 336. In addition, the individual can add or remove terms from the query window using the search center 320. Once the search terms have been manipulated as desired, the individual selects either the enter button 340 or the search button 314 to send the terms to the selected search indexer.

Referring now to FIGS. 5 and 7, the individual can select a search result in the browser window 302 to load the selected web page in the browser window 302. In some embodiments, as the page loads, a page rank indicator 710 provides an indication of whether or not the page that is displayed is already included in the individual's PKP, as well as the relevance of the loaded page as calculated by the content analyzer module 270 described above. Other methods can be used to indicate relevance, as describe above. For example, in one alternative embodiment, a separate window pops up to provide an indication of the relevance of particular content. Other configurations are possible.

The individual can review the content shown in the browser window 302 and select the positive or negative buttons (e.g., “thumbs up” or “thumbs down”) from the page relevance buttons 318 to indicate whether or not the page is relevant to the interest collection. If the individual selects the positive relevance button from the page relevance buttons 318, the page is added to the interest collection and weighted more highly. If the individual selects the negative relevance button from the page relevance buttons 318, the page weight is lowered and/or the page is removed from the interest collection. The individual can select the search button 314 to return the search results to the browser window 302.

Referring now to FIG. 8, once the individual selects the browse interest collection button 316, the content in the selected interest collection is shown in the browser window 302. Each page entry includes page relevance buttons 810 that allow the individual to indicate whether or not the entry is relevant to the interest collection. If the individual selects the positive button, the relevance of the entry is increased. Conversely, if the individual selects the negative button, the relevance of the entry is decreased. The listing of the entries can be reordered upon input from the individual. Also, a relevance indicator 820 provides an indication of the ranking of the relevance of the page. In the example shown, each entry is ranked in relevance from “1” to “−1.” Other conventions can be used.

The individual can select a remove button 830 to remove the entry from the interest collection. Also, the individual can enter a relevancy number into box 840 to remove all entries having equal to or less than the entered relevancy number. A classification button 850 can be selected to manually reclassify the links based on the individual's feedback.

Referring now to FIGS. 9-23, another example user interface 900 is shown. The user interface 900 is similar to the user interface 300 described above, except that the user interface 900 includes a different layout and different functionality.

Referring now to FIG. 9, the user interface 900 includes a toolbar 902. The toolbar 902 includes a dropdown 904 that allows the individual to name a new interest collection. The toolbar 902 also includes a keyword entry box 906 that allows the individual to enter one or more search terms and select the positive or negative buttons to add the keywords as positive or negative terms to the query. The toolbar 902 includes a browse interest collections button 908 that allows the individual to browse the individual's interest collections (see FIGS. 16-23). The toolbar 902 also includes a duplicate interest collection button 910 that allows the individual to duplicate the currently selected interest collection to create a new duplicate interest collection.

Referring now to FIG. 10, once the individual enters the desired keywords into the keyword entry box 906, the query is sent to the search indexer, and the search results from the search indexer are provided in the browser window 912. In the example shown, multiple search indexers can be queried to create a metasearch, and the results are combined into a single list, with redundant entries removed, as shown in the browser window 912. In alternative embodiments, a single search indexer can be queried.

Each entry in the search results shown in the browser window 912 includes an indicator 914 that lists the URL for the entry, as well as the source of the entry (e.g., Google, Yahoo, MSN, Ask). Each entry in the browser window 912 also includes a control center 916 that allows the individual to indicate the relevance of the entry (positive or negative), as well as a preview button 918 that, when selected, provides a preview window 920 showing a preview of the content associated with the entry, as shown in FIG. 11.

Referring now to FIG. 12, the control center 916 also includes an access button 922 that allows the individual to load the content associated with an entry, as shown in FIG. 13. The individual can select a return button 924 to return to the search results in the browser window 912.

Referring now to FIG. 14, once the individual refines the search results of a query sufficiently (as described above), the individual may be prompted at banner 926 to create an interest collection to store the information. The banner 926 allows the individual to name the interest collection, or elect not to create an interest collection at that time.

As shown in FIG. 15, the search terms for the current query are shown in a banner 930. The terms are highlighted to indicate whether each is a positive term (e.g., green) or a negative term (e.g., red) for the query. The individual can select one of the terms to remove it from the query. Further, as shown in FIG. 15, the individual can change the order of the terms. Once the order of the terms is changed, the list of results can be reordered accordingly. In the embodiment shown, terms are weighted from high to low from left to right. Other configurations are possible.

In addition, the individual can change the relevance ranking of an entry by selecting the up or down arrows in button 931, and can highlight positive or negative keywords to add to the query using highlighting button 933.

In the example shown, advertisements 931 are only generated in the user interface 900 once the individual defines an interest collection such that the rich query generator can generate a rich query to allow for advertisements to be selected that are meaningful and are relevant to the individual. In some examples, the advertisements 931 can be modified as the individual further modifies the interest collection.

Referring now to FIGS. 16-23, the individual can browse one or more interest collections by selecting the browse interest collection button 908. In the example shown, each interest collection is represented in the browser window 912 as an interest collection 913.

In the example shown, the interest collection 913 is in the form of a circle depicted in two or three dimensions. In general, each interest collection 913 includes a plurality of points, each point representing an entry within the interest collection. The points located close to the center of the interest collection are most relevant to the interest collection (i.e., have the highest ranking in the search results), while the points located at the edges of the interest collection have the least relevance. As describe further below, the individual can preview a search result by hovering over a particular point. The individual can remove a point from the interest collection by dragging the point outside of the interest collection to indicate that the search result is not relevant to the interest collection. This information can be used to further refine the result results that are included in the interest collection.

The individual selects a button 915 to allow the individual to manage the interest collection, including changing the name of the interest collection and deleting the interest collection. A button 917 can be selected to allow the individual to access the list of search results that are in the interest collection, as shown in FIG. 15. The individual can select button 919 to share the information in the interest collection with another individual. The individual selects right and left arrow buttons 921, 923 to cycle between different interest collections, and can select a zoom button 925 to zoom the view of the interest collection in and out.

As shown in FIG. 17, the individual hovers the cursor over a point in an interest collection to obtain information in an informational window 941 about the point. This information includes a preview button 940 that, when selected, provides the individual with a preview window 942 showing a preview of the content associated with the point in the interest collection, as shown in FIG. 18.

The individual selects an access button 944 provided in both the informational window 941 and the preview window 942 to access the content associated with the point, as shown in FIG. 19. The content is then loaded in the browser window 912, as shown in FIG. 20.

Still referring to FIG. 20, the user interface 900 also includes an interest collection control panel 950 that allows the individual to select among different interest collections using the dropdown 952 (see FIG. 21).

As shown in FIG. 22, the list of interest collections is also provided in the interest collection control panel 950. The individual can select multiple interest collections to display in the browser window 912. Overlap between two interest collections indicates that the interest collections share content. In the example shown, each interest collection is represented as a circle, and the size and position of each circle can be varied. For example, the larger circles indicate interest collections with more content.

Also, the size and position of the circle depicting an interest collection can increase or decrease based on the individual's interaction with the particular interest collection. For example, if the individual fails to access a particular interest collection for a period of time, the interest collection can decrease in size and prominence. The size and/or position can increase when later accessed. The size and prominence can also be based on other factors, such as time. For example, a particular interest collection may only be relevant for a certain period of time each year (e.g., tax season). As that time of year approaches, the depiction of the circle associated with that interest collection can increase in size and/or prominence. After the time period is over, the circle can again decrease. Other configurations are possible.

As shown in FIG. 23, the interest collection control panel 950 also includes a filter box 954 into which the individual can input terms. The terms are used to filter the interest collections, and the only the interest collections that match the terms are displayed in the interest collection control panel 950 and the browser window 912.

Referring now to FIG. 24, an example method 970 for creating an interest collection is shown. Initially, at operation 972, the individual provides one or more search terms to perform a discrete search. Next, at operation 974, the results of the search are received. At operation 976, the individual reviews the results and provides feedback (explicit and implicit). Once the search results are refined to a given level, the individual creates an interest collection at operation 978. After creation of the interest collection, the individual can continue to provide feedback to further refine the contents of the interest collection, and additional information can be added by crawling the most relevant content in the interest collection.

Referring now to FIG. 25, an example method 980 for analyzing content for inclusion in the personal knowledge profile is shown. Initially, at operation 982, the text of the content is analyzed. For example, the content can be found during a crawl and converted into text for analysis. Next, at operation 984, the relevance of the content is determined using information in the personal knowledge profile. At operation 986, a determination is made as to whether or not the content is relevant. If the content is determined to be relevant, control is passed to operation 988, and the content is added to one or more interest collections in the PKP. Alternatively, if the content is found not be relevant, control is passed back to operation 982.

Referring now to FIG. 26, another example system 1000 is shown. The system 1000 is similar to the system 100 described above, in that the system 1000 allows an individual to identify relevant content (e.g., text, pictures, video, etc.) in an online environment.

In the example shown, the system 1000 includes computing devices, such as a user computer 1010 that communicates with a central server 1020 through a network. The system 1000 is a server-side system, in that the content is processed and stored on the central server 1020, which includes one or more computing devices. As described above, the individual can use user computer 1010 to access the central server 1020 to obtain content. For example, the individual can use a browser running on the user computer 1010 to access content specific to the individual on the central server 1020.

In the examples shown, the content for the central server 1020 is accessed from various sources. These sources can include aggregate content providers 1030, API content providers 1040, and search content providers 1040.

In the example shown, the aggregate content providers 1030 include services that aggregate online content and provide the content for further processing and/or use. For example, the aggregate content providers 1030 may provide a database of content harvested from one or more online blogging sites. This database can be provided to the central server 1020, whereat further processing of the content can be done, as described further below.

The API content providers 1040 are online web sites or environments that provide for APIs that allow content from the sites to be harvested. For example, an online social networking site, such as Facebook or MySpace, can provide an API to allow content from the site to be accessed by the central server 1020. In this manner, content from the social networking site can be accessed and processed by the central server 1020.

The search content providers 1040 include one or more search indexers, such as Google, Yahoo, MSN, and Ask, that actively index the contents of the Internet. The search content providers 1040 can provide searching capabilities so that the central server 1020 can access content by forwarding one or more queries to the search content providers 1040 to search for and identify relevant content.

Other sources of online content can also be used. In example embodiments, the central server 1020 uses content from one or more of the aggregate content providers 1030, API content providers 1040, and search content providers 1040. Based on input from the individual, the central server 1020 filters the resulting content and provides the individual's user computer 1010 with content that may be relevant for the individual.

For example, in one embodiment, the central server 1020 receives one or more keywords from the individual based on the individual's interests. The keywords can include both positive keywords (i.e., words describing the content the individual is seeking) and negative keywords (i.e., content to exclude). The central server 1020 processes the content based on the keywords and provides content that may be relevant to the individual's user computer 1010. In other embodiments, other types of feedback, such as those described above, can also be used by the central server 1020 to filter content that is delivered to the individual.

In the example shown, the relevant content is streamed by the central server 1020 to the user computer 1010, which displays the content for the individual. In one embodiment, the user computer 1010 provides an interface that allows the individual to review the content and provide feedback to the central server 1020 based on the relevance of the content, such as that described above. For example, the user computer 1010 can provide one or more feeds of content that the user can review. These feeds can scroll, so that newer content is shown at the top of the feed. The individual can select the content that is relevant, and deselect the content that is not. For example, the individual can provide scoring (positive or negative) based on the relevance of the content. The central server 1020 can change the future content that is delivered to the individual based on this feedback.

In some embodiments, the central server 1020 can be configured as desired to filter out more or less content as desired by the individual. For example, the individual can set the central server 1020 to filter more content, so that only the most relevant content is delivered to the individual. Alternatively, the individual can set the central server 1020 to filter less material, so that a greater total amount of content is delivered to the user. In such a configuration, the central server 1020 can be configured to flag content that appears more relevant, so that the individual can receive more content while having the most relevant content flagged for easier identification.

Referring now to FIG. 27, additional details of the central server 1020 are shown. The central server 1020 includes an aggregator module 1012, a feedback module 1014, a filter module 1016, and a streaming module 1018.

The aggregator module 1012 receives content from a plurality of sources, such as the aggregate content providers 1030, API content providers 1040, and search content providers 1040. Other sources of content can also be used. In the example shown, the aggregator module 1012 is programmed to index the content so that the content can be searched.

The feedback module 1014 is programmed to receive input from the individual, such as keywords, that assist in defining the relevant content for the individual. In other examples, other forms of feedback, such as behavioral feedback as described above, can also be gathered by the feedback module 1014.

The filter module 1016 is programmed to filter the content and identify content that may be relevant to the individual. The filter module 1016 performs at least part of the filtering function based on the feedback provided from the feedback module 1014.

The streaming module 1018 delivers relevant content to the individual's computer. In example embodiments, the content can be streamed to the user's computer in various forms, such as a feed. Other forms of delivery can also be used.

In some embodiments, described herein, advertising is voluntary, in that the individual decides whether or not to accept advertisements or participate in an individual advertising arrangement. If the individual does decide to accept advertisements, the individual's interest collections are made available for advertisers to review. This is an anonymous process, such that the advertisers do not know whom (i.e., which individual) is associated with a particular interest. Advertisers can then bid on the leads. The winning bidder for a lead makes the payment to the system, and then an advertisement from the winning bidder is sent to the individual through the program on the individual's computer. If the individual decides to purchase goods or services, the transaction can be is handled between the individual and the advertiser. In some configurations, the advertiser pays a fee to the system if a transaction is completed.

In other examples, advertisements are not voluntary, but advertisements are only presented when the search results have been refined sufficiently so that only targeted advertisements are displayed. For example, as described above, advertisements can be displayed when the individual defines an interest collection such that a rich query can be formed to identify the advertisements. In this manner, the advertisements are targeted to the subject matter of the interest collection so as to be of interest to the individual.

Advertisements can take various forms. For example, the advertisements can be static and/or video advertisements. Also, email advertisements can be used for those individuals who allow contact through email. Other configurations are possible.

A plurality of user interfaces are illustrated and described herein. These interfaces are examples only, and the look and feel of the interfaces, as well as the underlying logic driving the interfaces, can be modified without departing from the principles described herein.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. A computing device that filters online content to be delivered to an individual, the computing device comprising:
a processor; and
a computer readable storage medium storing instructions that, when executed by the processor, cause the computing device to:
receive content from a plurality of sources, and to index the content;
receive input from the individual to indicate a relevance of certain of the content;
filter the content based on the input from the individual and identify relevant content for the individual; and
deliver the relevant content to the individual.
